(19) United States
(12) Patent Application Publication
(10) Pub. No.: US 2025/0244689 A1
(43) Pub. Date: Jul. 31, 2025

(54) POSITIVELY CHARGEABLE ELECTROPHOTOGRAPHIC PHOTORECEPTOR, PROCESS CARTRIDGE, AND IMAGE FORMING APPARATUS

(71) Applicant: FUJIFILM BUSINESS INNOVATION CORP., Tokyo (JP)

(72) Inventors: Keisuke KUSANO, Kanagawa (JP); Kenta IDE, Kanagawa (JP); Fuyuki KANO, Kanagawa (JP); Yoichi KIGOSHI, Kanagawa (JP); Yuki OYAMADA, Kanagawa (JP); Kohei TAKAOKA, Kanagawa (JP)

(73) Assignee: FUJIFILM BUSINESS INNOVATION CORP., Tokyo (JP)

(21) Appl. No.: 18/806,757

(22) Filed: Aug. 16, 2024

(30) Foreign Application Priority Data
Jan. 29, 2024 (JP) 2024-011251

(51) Int. Cl. G03G 5/05

(52) U.S. Cl. CPC G03G 5/0596; G03G 5/0564; G03G 2215/00957; G03G 2215/00962; G03G 2221/183

(57) ABSTRACT

A positively chargeable electrophotographic photoreceptor includes a single layer-type photosensitive layer that contains a hole transport material, an electron transport material, a charge generation material, and a binder resin, in which the binder resin contains a resin A having an elastic deformation rate of 53.0% or more and a resin B having an elastic deformation rate difference of 12% or more and 17% or less with respect to the resin A.

### CROSS-REFERENCE TO RELATED APPLICATIONS

This application is based on and claims priority under 35 USC 119 from Japanese Patent Application No. 2024-011251 filed Jan. 29, 2024.

### BACKGROUND

### (i) Technical Field

The present disclosure relates to a positively chargeable electrophotographic photoreceptor, a process cartridge, and an image forming apparatus.

### (ii) Related Art

International Publication No. 2018/154740 discloses a positively chargeable electrophotographic photoreceptor that includes a conductive support and a single layer-type photosensitive layer disposed on the conductive support and containing a charge generation material, a hole transport material, an electron transport material, and a binder resin, in which the charge generation material contains at least titanyl phthalocyanine and in which the contact angle between the surface of the outermost layer and water is in the range of 81° or more and 87° or less.

Japanese Unexamined Patent Application No. 2010-237555 discloses a single layer-type electrophotographic photoreceptor to be used in an image forming apparatus equipped with a roller cleaning system, the electrophotographic photoreceptor including a substrate that does not have an oxide coating film formed by anodizing, and a photosensitive layer disposed on the substrate and containing at least a charge generation material, a hole transport agent, an electron transport agent, and a binder resin, in which the binder resin is a polycarbonate resin having a viscosity-average molecular weight in the range of 10,000 to 40,000, the photosensitive layer has a thickness in the range of 20 to 45 μm, and the absolute value of the positive/negative dielectric withstanding voltage of the single layer-type electrophotographic photoreceptor as measured in accordance with JIS C 2110 is 6 kV or more.

### SUMMARY

Aspects of non-limiting embodiments of the present disclosure relate to providing a positively chargeable electrophotographic photoreceptor having excellent corrosion-induced color spot generation reducing properties and wear resistance compared to when the binder resin in a single layer-type photosensitive layer contains a resin A having an elastic deformation rate of 53.0% or more and a resin B having an elastic deformation rate difference of less than 12% or more and 17% with respect to the resin A.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a positively chargeable electrophotographic photoreceptor including a single layer-type photosensitive layer that contains a hole transport material, an electron transport material, a charge generation material, and a binder resin, in which the binder resin contains a resin A having an elastic deformation rate of 53.0% or more and a resin B having an elastic deformation rate difference of 12% or more and 17% or less with respect to the resin A.

### BRIEF DESCRIPTION OF THE DRAWINGS

Exemplary embodiments of the present disclosure will be described in detail based on the following figures, wherein:

FIG. 1 is a partial cross-sectional view schematically illustrating one example of the layer structure of an electrophotographic photoreceptor according to an exemplary embodiment;

FIG. 2 is a schematic cross-sectional view of one example of an image forming apparatus according to one exemplary embodiment; and

FIG. 3 is a schematic cross-sectional view of another example of an image forming apparatus according to one exemplary embodiment.

### DETAILED DESCRIPTION

In the description below, some examples of the present disclosure are described in detail as exemplary embodiments.

In the present description, a numerical range expressed by using “to” indicates a range that includes the number preceding “to” and the number following “to” as the minimum value and the maximum value, respectively.

In any stepwise numerical range recited in the present description, the upper limit or the lower limit of one numerical range may be substituted with the upper limit or the lower limit of a different stepwise numerical range. In any numerical range recited in the present description, the upper limit or the lower limit of that numerical range may be substituted with any value disclosed in Examples.

In the present description, the term “step” refers not only to an independent step but also to any feature that fulfills the intended purpose of that step although such a feature may not be clearly distinguishable from other steps.

When any exemplary embodiment in the present description is described with reference to the drawings, that exemplary embodiment is not limited to the features illustrated in the drawings. In addition, the size of each of the members in the drawings is schematic, and the relative size relationships among the members are not limited to the ones illustrated in the drawings.

In the present description, each component may contain multiple corresponding substances. In exemplary embodiments, when the amount of a component in a composition is described and when there are two or more substances that correspond to that component in the composition, the amount is the total amount of the two or more substances in the composition unless otherwise noted.

In the present description, particles corresponding to each of the components may include multiple types of particles. When there are two or more types of particles corresponding to a component, the particle size of this component is the value from a mixture of the multiple types of particles present in the composition unless otherwise noted.

In the present description, an alkyl group and an alkylene group may be linear, branched, or cyclic unless otherwise noted.

In the present description, a group such as an organic group, an aromatic ring, a linking group, an alkyl group, an alkylene group, an aryl group, an aralkyl group, an alkoxy group, or an aryloxy group may have a hydrogen atom therein substituted with a halogen atom.

In the present description, when a compound is represented by a structural formula, the symbols representing carbon atoms and hydrogen atoms (C and H) in hydrocarbon groups and/or hydrocarbon chains may be omitted.

In the present description, a “constitutional unit” of a copolymer or a resin is synonymous with a monomer unit.

In the present description, ppm is short for “parts per million” and is based on mass.

### Positively Chargeable Electrophotographic Photoreceptor

A positively chargeable electrophotographic photoreceptor according to an exemplary embodiment includes a single layer-type photosensitive layer that contains a hole transport material, an electron transport material, a charge generation material, and a binder resin, and the binder resin contains a resin A having an elastic deformation rate of 53.0% or more and a resin B having an elastic deformation rate difference of 12% or more and 17% or less with respect to the resin A.

The positively chargeable electrophotographic photoreceptor of this exemplary embodiment may include a conductive substrate and a single layer-type photosensitive layer disposed on the conductive substrate.

The positively chargeable electrophotographic photoreceptor of this exemplary embodiment may further include other layers (for example, an undercoat layer and an intermediate layer).

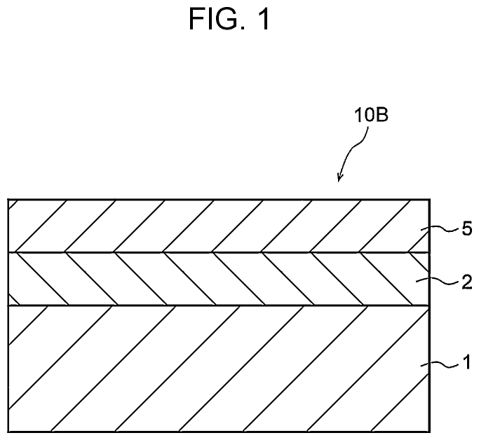

FIG. 1 is a partial cross-sectional view schematically illustrating one example of the layer structure of the positively chargeable electrophotographic photoreceptor according to an exemplary embodiment. A photoreceptor 10B illustrated in FIG. 1 has a single layer-type photosensitive layer. The photoreceptor 10B has a structure in which an undercoat layer 2 and a photosensitive layer 5 are stacked in this order on a conductive substrate 1. The photoreceptor 10B may include an intermediate layer (not illustrated) between the undercoat layer 2 and the photosensitive layer 5. The undercoat layer 2 is optional.

According to a typical single layer-type electrophotographic photoreceptor, in principle, the electrical characteristics are determined by the electron mobility rate control, and thus it is general practice to employ a positive charging system with which the electron transport distance can be shortened.

However, in a positive charging system image forming apparatus, when the actual apparatus is run for a long period of time at high temperature and high humidity, leakage current occurs at the electrical singular point of the photosensitive layer, resulting in corrosion of the photosensitive layer that develops into color spots.

In the positively chargeable electrophotographic photoreceptor of this exemplary embodiment, the binder resin in the single layer-type photosensitive layer contains a resin A having an elastic deformation rate of 53.0% or more and a resin B having an elastic deformation rate difference of 12% to 17% with respect to the resin A, in other words, the binder resin contains a highly durable resin A that has an elastic deformation rate of 53.0% or more and a resin B having an elastic deformation rate difference of 12% to 17% with respect to the resin A; thus, this difference in durability between the resin A and the resin B creates physical protrusions and recesses in the surface of the single layer-type photosensitive layer when the actual apparatus is run.

It is assumed that, since the current flows into the recesses in the surface of the single layer-type photosensitive layer, corrosion of the single layer-type photosensitive layer is reduced, the property of inhibiting color spot generation caused by corrosion is enhanced, and the wear resistance is improved by incorporation of a highly durable resin A having an elastic deformation rate as high as 53.0% or more.

In the description below, the positively chargeable electrophotographic photoreceptor may be simply referred to as an “electrophotographic photoreceptor”.

### Single Layer-Type Photosensitive Layer

A positively chargeable electrophotographic photoreceptor according to an exemplary embodiment includes a single layer-type photosensitive layer that contains a hole transport material, an electron transport material, a charge generation material, and a binder resin.

### Binder Resin

The binder resin in the single layer-type photosensitive layer in the positively chargeable electrophotographic photoreceptor according to this exemplary embodiment contains a resin A having an elastic deformation rate of 53.0% or more and a resin B having an elastic deformation rate difference of 12% or more and 17% or less with respect to the resin A.

From the viewpoint of reducing generation of color spots caused by corrosion (hereinafter may be simply referred to as “color spot generation reducing property”), the resin A and the resin B may be incompatible to each other.

From the viewpoint of the color spot generation reducing property, the resin A and the resin B in the single layer-type photosensitive layer preferably form an interpenetrating polymer network structure or a sea-island structure according to the blend ratio thereof, and more preferably form an interpenetrating polymer network structure.

### Elastic Deformation Rate of Resin A

The elastic deformation rate of the resin A is 53.0% or more, and from the viewpoints of wear resistance and the color spot generation reducing property, the elastic deformation rate of the resin A is preferably 53.0% or more and 75.0% or less, more preferably 54.0% or more and 70.0% or less, and yet more preferably 56.0% or more and 65.0% or less.

### Elastic Deformation Rate of Resin B

The elastic deformation rate of the resin B is preferably 36.0% or more and less than 53.0%, more preferably 40.0% or more and 50.0% or less, and yet more preferably 42.0% or more and 48.0% or less from the viewpoints of wear resistance and the color spot generation reducing property.

### Elastic Deformation Rate Difference Between Resin B and Resin A

The elastic deformation rate difference between the resin B and the resin A is 12% or more and 17% or less, and from the viewpoint of the color spot generation reducing property, the elastic deformation rate difference is preferably 12% or more and 16% or less, more preferably 12% or more and 15% or less, and yet more preferably 12.5% or more and 14.5% or less.

The elastic deformation rate of the resin B is preferably 12% or more and 17% or less smaller than the elastic deformation rate of the resin A from the viewpoint of the color spot generation reducing property.

The elastic deformation rate of a resin in this exemplary embodiment is measured as follows.

The elastic deformation rate of a resin is determined as follows.

The total deformation amount of a photosensitive layer under load is split into an elastic deformation amount and a plastic deformation amount, and the elastic deformation rate is defined as elastic deformation rate=elastic deformation amount/total deformation amount. Specifically, the elastic deformation rate is calculated by measuring the indentation depth and the indentation depth-stress curve by using Nanoindenter SA2 produced by MTS with a DCM head and a diamond Berkovich indenter. Specifically, the indentation depth Dmax (nm) observed in an environment having a temperature of 24° C. and a humidity of 50% with an indentation depth set to 500 nm as the measurement conditions and the indentation depth D1 (nm) observed when the load is completely removed are used to calculate the elastic deformation rate R from the following equation.

$$Elastic deformation rate = ( D max - D 1 ) / D max$$

### Mass Ratio of Resin A Content to Resin B Content (MA/MB)

The mass ratio MA/MB of the resin A content MA to the resin B content MB in the single layer-type photosensitive layer is preferably 0.1 or more and 10 or less, more preferably 0.25 or more and 4 or less, yet more preferably 0.4 or more and 2.5 or less, and particularly preferably 0.5 or more and 2.0 or less from the viewpoint of the color spot generation reducing property.

The mass ratio MA/MB of the resin A content MA to the resin B content MB in the single layer-type photosensitive layer is preferably 0.4 or more and 10 or less, more preferably 0.5 or more and 10 or less, and yet more preferably 0.75 or more and 9 or less from the viewpoint of the wear resistance.

Examples of the binder resin used in the single layer-type photosensitive layer include polycarbonate resin, polyester resin, methacrylic resin, acrylic resin, polyvinyl chloride resin, polyvinylidene chloride resin, polystyrene resin, polyvinyl acetate resin, styrene-butadiene copolymer, vinylidene chloride-acrylonitrile copolymer, vinyl chloride-vinyl acetate copolymer, vinyl chloride-vinyl acetate-maleic anhydride copolymer, silicone resin, silicone alkyd resin, phenol-formaldehyde resin, styrene-alkyd resin, poly-N-vinylcarbazole, and polysilane.

From the viewpoints of the wear resistance and the color spot generation reducing property, the resin A is preferably a polyester resin or a polycarbonate resin and is more preferably a polyester resin.

From the viewpoints of the wear resistance and the color spot generation reducing property, the resin A is particularly preferably a polyarylate resin among the polyester resins.

Examples of the polyarylate resin include polycondensed products obtained from bisphenols and aromatic dicarboxylic acids.

Furthermore, from the viewpoints of the wear resistance and the color spot generation reducing property, the resin A may have a biphenyl structure.

The weight-average average molecular weight (Mw) of the resin A is preferably 30,000 or more and 300,000 or less, more preferably 40,000 or more and 250,000 or less, and yet more preferably 50,000 or more and 200,000 or less.

The weight-average average molecular weight of a resin is a polystyrene-equivalent weight-average average molecular weight measured by gel permeation chromatography (GPC). Tetrahydrofuran is used as the eluent in the GPC.

From the viewpoints of the wear resistance and the color spot generation reducing property, the resin B is preferably a polyester resin or a polycarbonate resin and is more preferably a polycarbonate resin.

Furthermore, from the viewpoints of the wear resistance and the color spot generation reducing property, the resin B may have a biphenyl structure.

The viscosity-average molecular weight of the resin B is preferably 50,000 or less, more preferably 45,000 or less, and yet more preferably 40,000 or less from the viewpoint of the color spot generation reducing property. The viscosity-average molecular weight of the resin B is preferably 20,000 or more from the viewpoint of the wear resistance.

The viscosity-average molecular weight of a resin in this exemplary embodiment is measured by the following one-point measurement method.

First, a single layer-type photosensitive layer to be measured is exposed from the photoreceptor. Next, one part of the single layer-type photosensitive layer is cut out to prepare a measurement specimen.

Next, the resin is extracted from the measurement specimen. One gram of the extracted resin is dissolved in 100 cm³ of methylene chloride, and the specific viscosity ηsp thereof is measured with a Ubbelohde viscometer in a measurement environment at 25° C. Next, the relational expression ηsp/c=[η]+0.45 [η]²c (where c represents the concentration (g/cm³)) is used to determine the limiting viscosity [η] (cm³/g), and the formula given by H. Schnell, [η]=1.23×10⁻⁴ Mv^{0.83} is used to determine the viscosity-average molecular weight Mv.

### Polyarylate Resin

The polyarylate resin may be as follows.

The polyarylate resin may have at least a dicarboxylic acid unit (A) represented by formula (A) and a diol unit (B) represented by formula (B).

The polyarylate resin may include dicarboxylic acid units other than the dicarboxylic acid unit (A).

The polyarylate resin may include diol units other than the diol unit (B).

The dicarboxylic acid unit (A) is a constitutional unit represented by formula (A) below.

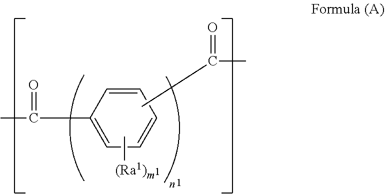

In formula (A), n¹ is 1, 2, or 3, n¹ m¹ are each independently 0, 1, 2, 3, or 4, and m¹ Ra¹ are each independently an alkyl group having 1 or more and 10 or less carbon atoms, an aryl group having 6 or more and 12 or less carbon atoms, or an alkoxy group having 1 or more and 6 or less carbon atoms.

In formula (A), n¹ is 1, 2, or 3, and is preferably 2.

When n¹ is 2, the two benzene rings in formula (A) may have the same or different m¹ and Ra¹.

When n¹ is 3, the three benzene rings in formula (A) may have the same or different m¹ and Ra¹.

In formula (A), when n¹ is 2 or 3, the linking position of the benzene rings may be ortho, meta, or para, and is preferably meta or para.

In formula (A), m¹ is 0, 1, 2, 3, or 4, preferably 0, 1, or 2, more preferably 0 or 1, and yet more preferably 0.

When m¹ is 2, the two Ra¹ bonded to the same benzene ring may be the same group or different groups.

When m¹ is 3, the three Ra¹ bonded to the same benzene ring may be the same group or different groups.

When m¹ is 4, the four Ra¹ bonded to the same benzene ring may be the same group or different groups.

In formula (A), the alkyl group having 1 or more and 10 or less carbon atoms may be linear, branched, or cyclic. The number of carbon atoms in the alkyl group is preferably 1 or more and 6 or less, more preferably 1 or more and 4 or less, and yet more preferably 1 or 2.

In formula (A), the aryl group having 6 or more and 12 or less carbon atoms may be monocyclic or polycyclic. The number of carbon atoms in the aryl group is preferably 6 or more and 10 or less and more preferably 6 or more and 9 or less.

In formula (A), the alkyl group in the alkoxy group having 1 or more and 6 or less carbon atoms may be linear, branched, or cyclic. The number of carbon atoms in the alkyl group in the alkoxy group having 1 or more and 6 or less carbon atoms is preferably 1 or more and 4 or less, more preferably 1 or more and 3 or less, and yet more preferably 1 or 2.

Examples of the linear alkyl group having 1 or more and 10 or less carbon atoms in formula (A) include a methyl group, an ethyl group, an n-propyl group, an n-butyl group, an n-pentyl group, an n-hexyl group, an n-heptyl group, an n-octyl group, an n-nonyl group, and an n-decyl group.

Examples of the branched alkyl group having 3 or more and 10 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

Examples of the cyclic alkyl group having 3 or more and 10 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and a polycyclic (for example, bicyclic, tricyclic, or spirocyclic) alkyl group in which these monocyclic alkyl groups are linked.

Examples of the aryl group having 6 or more and 12 or less carbon atoms in formula (A) include a phenyl group, a biphenyl group, a 1-naphtyl group, and a 2-naphthyl group.

Examples of the linear alkoxy group having 1 or more and 6 or less carbon atoms in formula (A) include a methoxy group, an ethoxy group, an n-propoxy group, an n-butoxy group, an n-pentyloxy group, and an n-hexyloxy group.

Examples of the branched alkoxy group having 3 or more and 6 or less carbon atoms in formula (A) include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms in formula (A) include a cyclopropoxy group, a cyclobutoxy group, a cyclopentyloxy group, and a cyclohexyloxy group.

In formula (A), when m¹ is 1, 2, 3, or 4, Ra¹ is preferably a linear alkyl group having 1 or more and 6 or less carbon atoms or a branched alkyl group having 3 or more and 6 or less carbon atoms, more preferably a linear alkyl group having 1 or more and 4 or less carbon atoms or a branched alkyl having 3 or 4 carbon atoms, and yet more preferably a methyl group or an ethyl group.

Specific examples of the dicarboxylic acid unit (A) are dicarboxylic acid units (A-1) to (A-13) below. The dicarboxylic acid unit (A) is not limited to these.

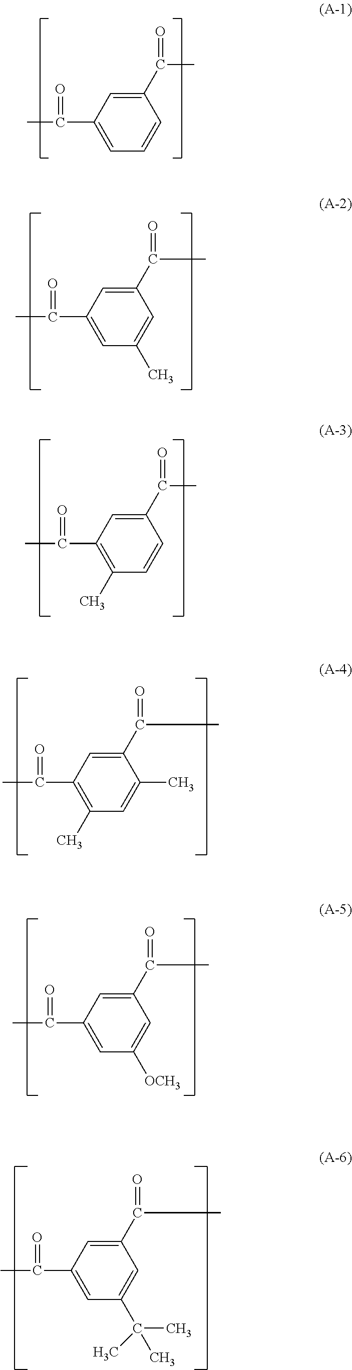

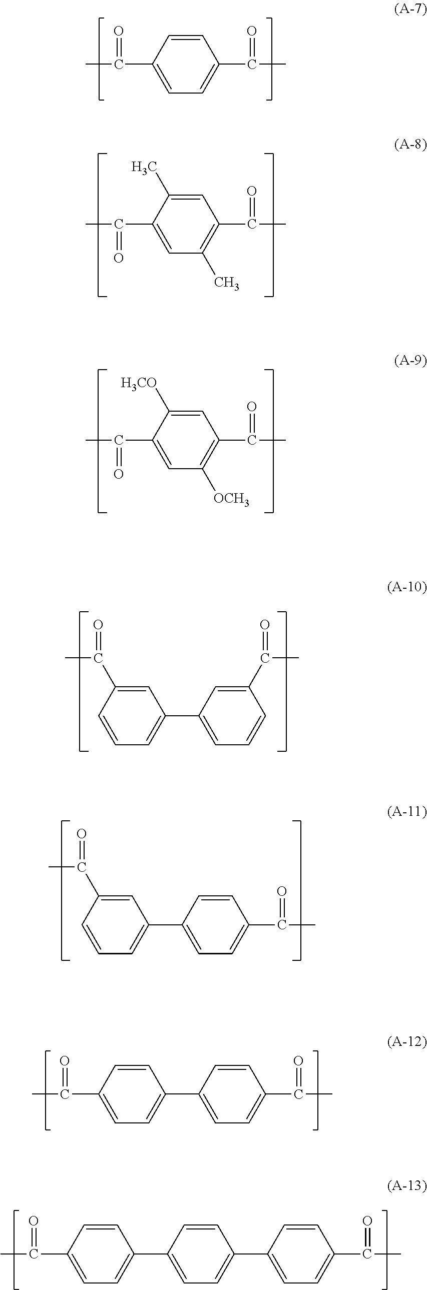

The dicarboxylic acid unit (A) is preferably (A-1), (A-7), and (A-10) to (A-13) of the aforementioned specific examples, more preferably (A-10) to (A-12), and yet more preferably (A-12).

There may be one or more than one dicarboxylic acid units (A) contained in the polyarylate resin.

The diol unit (B) is a constitutional unit represented by formula (B) below.

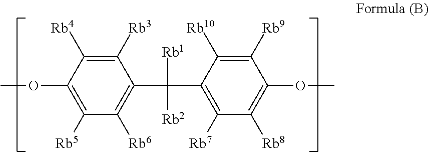

In formula (B), Rb¹ and Rb² are each independently a hydrogen atom, an alkyl group having 1 or more and 20 or less carbon atoms, an aryl group having 6 or more and 12 or less carbon atoms, or an aralkyl group having 7 or more and 20 or less carbon atoms; Rb³, Rb⁴, Rb⁵, Rb⁶, Rb⁷, Rb⁸, Rb⁹, and Rb¹⁰ are each independently a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms; and Rb¹ and Rb² may bond together to form a cyclic alkyl group.

In formula (B), the alkyl group having 1 or more and 20 or less carbon atoms represented by Rb¹ and Rb² may be linear, branched, or cyclic. The number of carbon atoms in the alkyl group is preferably 1 or more and 15 or less, more preferably 1 or more and 12 or less, and yet more preferably 1 or more and 10 or less.

In formula (B), the aryl group having 6 or more and 12 or less carbon atoms represented by Rb¹ and Rb² may be monocyclic or polycyclic. The number of carbon atoms in the aryl group is preferably 6 or more and 10 or less and more preferably 6 or more and 9 or less.

In formula (B), the aryl group in the aralkyl group having 7 or more and 20 or less carbon atoms represented by Rb¹ and Rb² may be monocyclic or polycyclic, and the alkyl group in the aralkyl group having 7 or more and 20 or less carbon atoms may be linear, branched, or cyclic. The number of carbon atoms in the aryl group is preferably 6 or more and 10 or less and more preferably 6 or more and 9 or less. The number of carbon atoms in the alkyl group is preferably 1 or more and 6 or less, more preferably 1 or more and 5 or less, and yet more preferably 1 or more and 4 or less.

In formula (B), the number of carbon atoms in a cyclic alkyl group that may be formed by Rb¹ and Rb² bonded together is preferably 5 or more and 15 or less and more preferably 6 or more and 12 or less.

In formula (B), the alkyl group having 1 or more and 10 or less carbon atoms represented by Rb³, Rb⁴, Rb⁵, Rb⁶, Rb⁷, Rb⁸, Rb⁹, and Rb¹⁰ may be linear, branched, or cyclic. The number of carbon atoms in the alkyl group is preferably 1 or more and 6 or less, more preferably 1 or more and 4 or less, and yet more preferably 1 or 2.

In formula (B), the aryl group having 6 or more and 12 or less carbon atoms represented by Rb³, Rb⁴, Rb⁵, Rb⁶, Rb⁷, Rb⁸, Rb⁹, and Rb¹⁰ may be monocyclic or polycyclic. The number of carbon atoms in the aryl group is preferably 6 or more and 10 or less and more preferably 6 or more and 9 or less.

In formula (B), the aryl group in the aralkyl group having 7 or more and 20 or less carbon atoms represented by Rb³, Rb⁴, Rb⁵, Rb⁶, Rb⁷, Rb⁸, Rb⁹, and Rb¹⁰ may be monocyclic or polycyclic, and the alkyl group in the aralkyl group having 7 or more and 20 or less carbon atoms may be linear, branched, or cyclic. The number of carbon atoms in the aryl group is preferably 6 or more and 10 or less and more preferably 6 or more and 9 or less. The number of carbon atoms in the alkyl group is preferably 1 or more and 6 or less, more preferably 1 or more and 5 or less, and yet more preferably 1 or more and 4 or less.

In formula (B), the alkyl group in an alkoxy group having 1 or more and 6 or less carbon atoms represented by Rb³, Rb⁴, Rb⁵, Rb⁶, Rb⁷, Rb⁸, Rb⁹, and Rb¹⁰ may be linear, branched, or cyclic. The number of carbon atoms in the alkyl group in the alkoxy group having 1 or more and 6 or less carbon atoms is preferably 1 or more and 4 or less, more preferably 1 or more and 3 or less, and yet more preferably 1 or 2.

Examples of the linear alkyl group having 1 or more and 20 or less carbon atoms in formula (B) include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

Examples of the branched alkyl group having 3 or more and 20 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

Examples of the cyclic alkyl group having 3 or more and 20 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and a polycyclic (for example, bicyclic, tricyclic, or spirocyclic) alkyl group in which these monocyclic alkyl groups are linked.

Examples of the aryl group having 6 or more and 12 or less carbon atoms in formula (B) include a phenyl group, a biphenyl group, a 1-naphtyl group, and a 2-naphthyl group.

Examples of the aralkyl group having 7 or more and 20 or less carbon atoms in formula (B) include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

Examples of the linear alkoxy group having 1 or more and 6 or less carbon atoms in formula (B) include a methoxy group, an ethoxy group, an n-propoxy group, an n-butoxy group, an n-pentyloxy group, and an n-hexyloxy group.

Examples of the branched alkoxy group having 3 or more and 6 or less carbon atoms in formula (B) include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms in formula (B) include a cyclopropoxy group, a cyclobutoxy group, a cyclopentyloxy group, and a cyclohexyloxy group.

In formula (B), Rb¹ and Rb² may each independently be a hydrogen atom, a linear alkyl group having 1 or more and 12 or less carbon atoms, a branched alkyl group having 1 or more and 12 or less carbon atoms, an aryl group having 6 or more and 10 or less carbon atoms, or an aralkyl group having 7 or more and 10 or less carbon atoms, or Rb¹ and Rb² may bond together to form a cyclic alkyl group having 5 or more and 12 or less carbon atoms.

In formula (B), Rb¹ and Rb² are more preferably each independently a hydrogen atom, a linear alkyl group having 1 or more and 10 or less carbon atoms, or a branched alkyl group having 1 or more and 10 or less carbon atoms, or Rb¹ and Rb² more preferably bond together to form a cyclic alkyl group having 5 or more and 12 or less carbon atoms.

In formula (B), Rb¹ and Rb² are yet more preferably each independently a hydrogen atom, a linear alkyl group having 1 or more and 10 or less carbon atoms, or a branched alkyl group having 1 or more and 10 or less carbon atoms.

In formula (B), at least one of Rb¹ and Rb² is preferably a linear alkyl group having 4 or more and 10 or less carbon atoms, a branched alkyl group having 4 or more and 10 or less carbon atoms, an aryl group having 6 or more and 10 or less carbon atoms, or an aralkyl group having 7 or more and 10 or less carbon atoms, or Rb¹ and Rb² preferably bond together to form a cyclic alkyl group having 5 or more and 12 or less carbon atoms.

In formula (B), at least one of Rb¹ and Rb² is more preferably a linear alkyl group having 4 or more and 10 or less carbon atoms or a branched alkyl group having 4 or more and 10 or less carbon atoms.

When at least one of Rb¹ and Rb² is as mentioned above, the other of Rb¹ and Rb² is preferably a hydrogen atom or a linear alkyl group having 1 or more and 3 or less carbon atoms.

The diol unit (B) may be a constitutional unit represented by formula (B′) below.

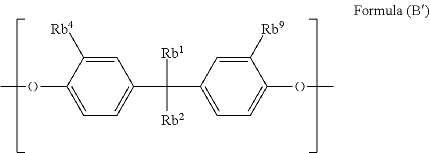

Rb¹, Rb², Rb⁴, and Rb⁹ in formula (B′) have the same definitions as Rb¹, Rb², Rb⁴, and Rb⁹ in formula (B), and preferable groups are also the same.

The diol unit (B) is preferably a diol unit represented by formula (B′) with Rb¹ being a hydrogen atom, a linear alkyl group having 1 or more and 3 or less carbon atoms, or a branched alkyl group having 3 carbon atoms, Rb² being a linear alkyl group having 4 or more and 10 or less carbon atoms, a branched alkyl group having 4 or more and 10 or less carbon atoms, an aryl group having 6 or more and 10 or less carbon atoms, or an aralkyl group having 7 or more and 10 or less carbon atoms, and Rb⁴ and Rb⁹ each independently being a hydrogen atom or a methyl group; and the diol unit (B) is more preferably a diol unit represented by formula (B′) with Rb¹ being a hydrogen atom or a methyl group, Rb² being a linear alkyl group having 4 or more and 10 or less carbon atoms or a branched alkyl group having 4 or more and 10 or less carbon atoms, and Rb⁴ and Rb⁹ each independently being a hydrogen atom or a methyl group.

Specific examples of the diol unit (B) are diol units (B-1) to (B-38) below. The diol unit (B) is not limited to these.

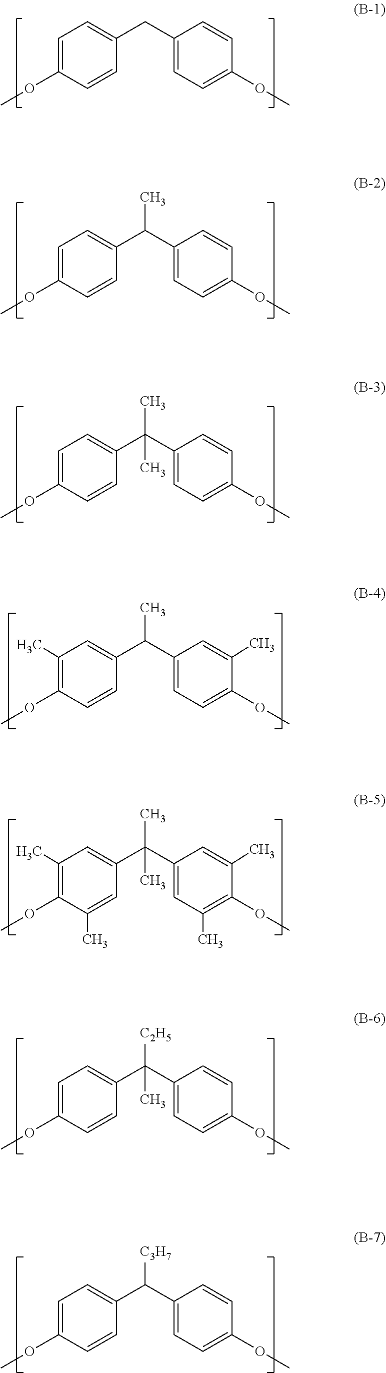

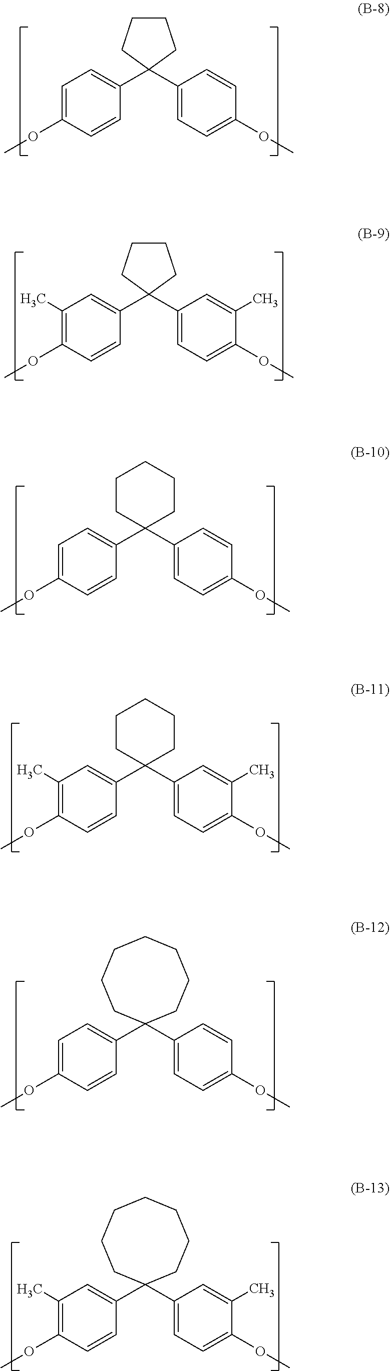

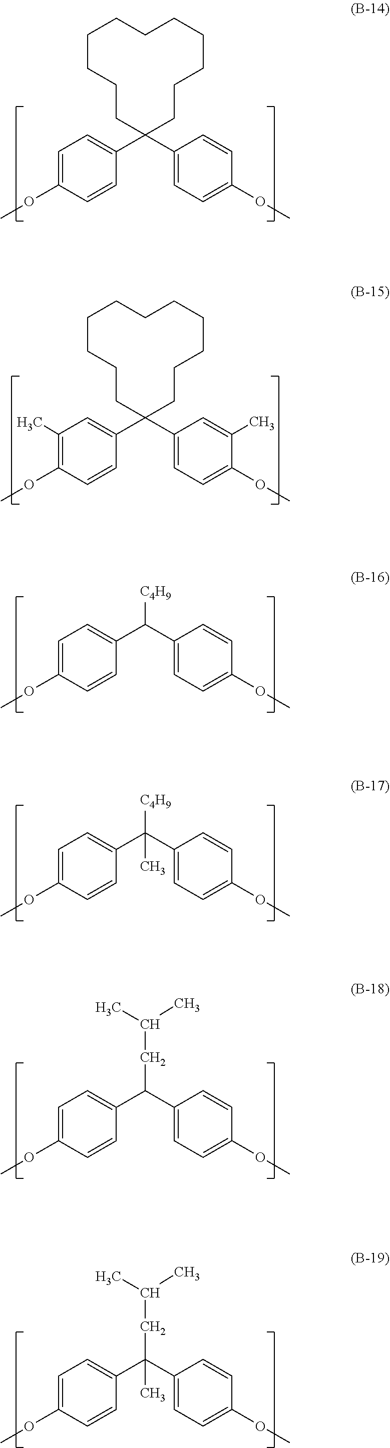

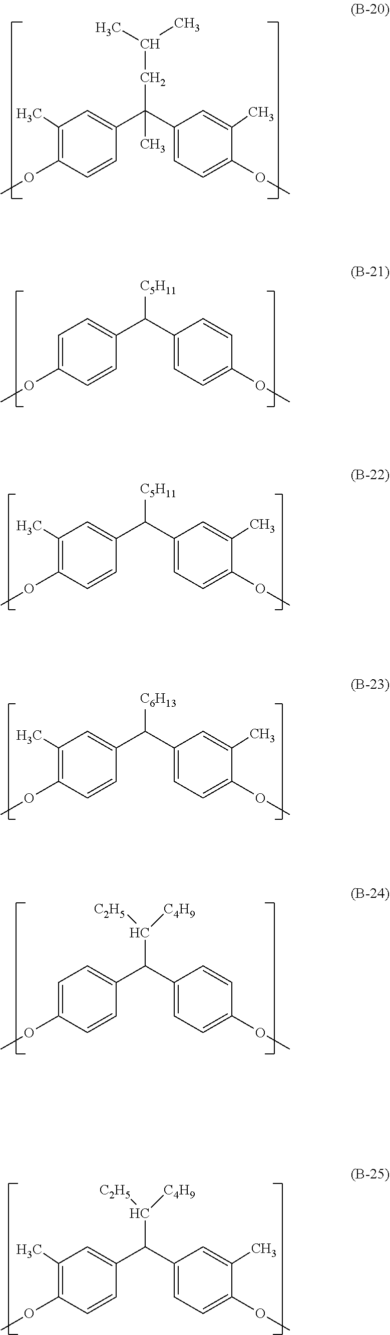

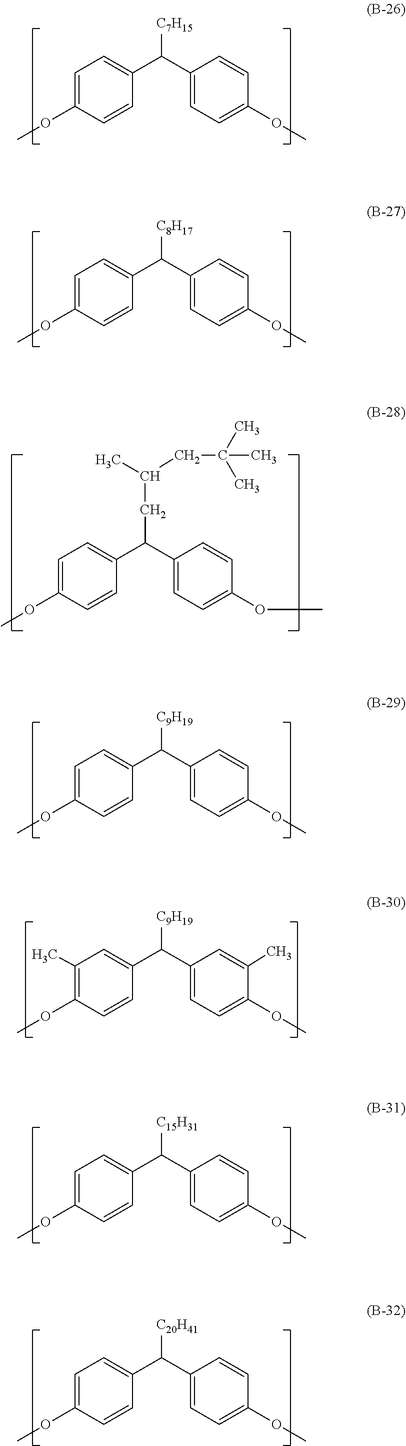

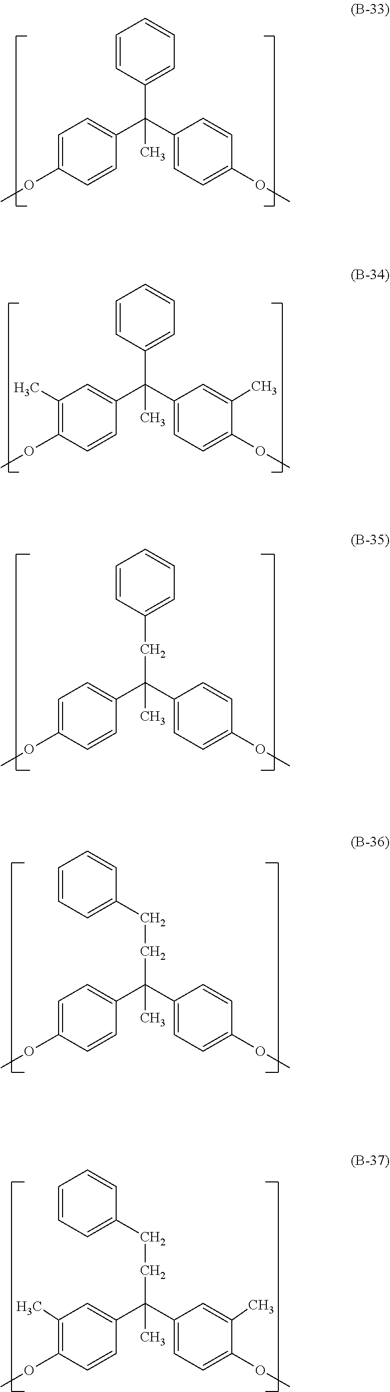

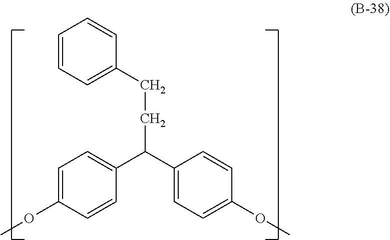

Among these, (B-19) is preferable as the diol unit (B).

There may be one or more than one diol units (B) contained in the polyarylate resin.

The mass ratio of the dicarboxylic acid unit (A) in the polyarylate resin may be 15 mass % or more and 60 mass % or less.

When the mass ratio of the dicarboxylic acid unit (A) is 15 mass % or more, the wear resistance of the photosensitive layer is excellent. From this viewpoint, the mass ratio of the dicarboxylic acid unit (A) is more preferably 20 mass % or more and yet more preferably 25 mass % or more.

When the mass ratio of the dicarboxylic acid unit (A) is 60 mass % or less, separation of the photosensitive layer is further reduced. From this viewpoint, the mass ratio of the dicarboxylic acid unit (A) is more preferably 55 mass % or less and yet more preferably 50 mass % or less.

The mass ratio of the diol unit (B) in the polyarylate resin may be 25 mass % or more and 60 mass % or less.

When the mass ratio of the diol unit (B) is 25 mass % or more, separation of the photosensitive layer is further reduced. From this viewpoint, the mass ratio of the diol unit (B) is more preferably 30 mass % or more and yet more preferably 35 mass % or more.

When the mass ratio of the diol unit (B) is 60 mass % or less, the solubility in a coating solution for forming a photosensitive layer is maintained, and the wear resistance is improved. From this viewpoint, the mass ratio of the diol unit (B) is more preferably 55 mass % or less and yet more preferably 50 mass % or less.

The polyarylate resin may include dicarboxylic acid units other than the dicarboxylic acid unit (A).

Examples of other dicarboxylic acid units include dicarboxylic acid units (C) represented by formula (C) below.

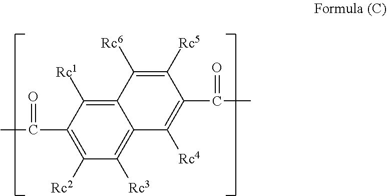

In formula (C), Rc¹, Rc², Rc³, Rc⁴, Rc⁵, and Rc⁶ are each independently a hydrogen atom, an alkyl group having 1 or more and 10 or less carbon atoms, an aryl group having 6 or more and 12 or less carbon atoms, or an alkoxy group having 1 or more and 6 or less carbon atoms.

In formula (C), the alkyl group having 1 or more and 10 or less carbon atoms may be linear, branched, or cyclic. The number of carbon atoms in the alkyl group is preferably 1 or more and 6 or less, more preferably 1 or more and 4 or less, and yet more preferably 1 or 2.

In formula (C), the aryl group having 6 or more and 12 or less carbon atoms may be monocyclic or polycyclic. The number of carbon atoms in the aryl group is preferably 6 or more and 10 or less and more preferably 6 or more and 9 or less.

In formula (C), the alkyl group in the alkoxy group having 1 or more and 6 or less carbon atoms may be linear, branched, or cyclic. The number of carbon atoms in the alkyl group in the alkoxy group having 1 or more and 6 or less carbon atoms is preferably 1 or more and 4 or less, more preferably 1 or more and 3 or less, and yet more preferably 1 or 2.

Implementation examples of the alkyl group, the aryl group, and the alkoxy group in formula (C) are the same as those groups described for formula (A).

In formula (C), Rc¹, Rc², Rc³, Rc⁴, Rc⁵, and Rc⁶ are preferably each independently a hydrogen atom, a linear alkyl group having 1 or more and 6 or less carbon atoms, or a branched alkyl group having 1 or more and 6 or less carbon atoms, more preferably a hydrogen atom, a linear alkyl group having 1 or more and 4 or less carbon atoms, or a branched alkyl group having 1 or more and 4 or less carbon atoms, yet more preferably a hydrogen atom, a linear alkyl group having 1 or more and 3 or less carbon atoms, or a branched alkyl group having 1 or more and 3 or less carbon atoms, and particularly preferably a hydrogen atom.

The dicarboxylic acid unit (C) is particularly preferably a 2,6-naphthalenedicarboxylic acid unit (unit (C-1) below).

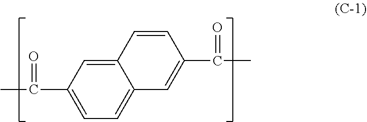

There may be one or more than one dicarboxylic acid units (C) contained in the polyarylate resin.

When the polyarylate resin has a dicarboxylic acid unit (C), the mass ratio of the dicarboxylic acid unit (C) in the polyarylate resin may be 1 mass % or more and 20 mass % or less.

Examples of other dicarboxylic acid units include dicarboxylic acid units (D) represented by formula (D) below.

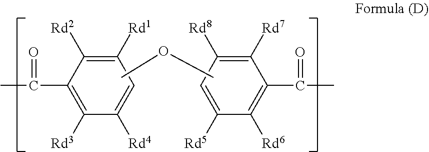

In formula (D), Rd¹, Rd², Rd³, Rd⁴, Rd⁵, Rd⁶, Rd⁷, and Rd⁸ are each independently a hydrogen atom, an alkyl group having 1 or more and 10 or less carbon atoms, an aryl group having 6 or more and 12 or less carbon atoms, or an alkoxy group having 1 or more and 6 or less carbon atoms.

In formula (D), the alkyl group having 1 or more and 10 or less carbon atoms may be linear, branched, or cyclic. The number of carbon atoms in the alkyl group is preferably 1 or more and 6 or less, more preferably 1 or more and 4 or less, and yet more preferably 1 or 2.

In formula (D), the aryl group having 6 or more and 12 or less carbon atoms may be monocyclic or polycyclic. The number of carbon atoms in the aryl group is preferably 6 or more and 10 or less and more preferably 6 or more and 9 or less.

In formula (D), the alkyl group in the alkoxy group having 1 or more and 6 or less carbon atoms may be linear, branched, or cyclic. The number of carbon atoms in the alkyl group in the alkoxy group having 1 or more and 6 or less carbon atoms is preferably 1 or more and 4 or less, more preferably 1 or more and 3 or less, and yet more preferably 1 or 2.

Implementation examples of the alkyl group, the aryl group, and the alkoxy group in formula (D) are the same as those groups described for formula (A).

In formula (D), Rd¹, Rd², Rd³, Rd⁴, Rd⁵, Rd⁶, Rd⁷, and Rd⁸ are preferably each independently a hydrogen atom, a linear alkyl group having 1 or more and 6 or less carbon atoms, or a branched alkyl group having 1 or more and 6 or less carbon atoms, more preferably a hydrogen atom, a linear alkyl group having 1 or more and 4 or less carbon atoms, or a branched alkyl group having 1 or more and 4 or less carbon atoms, yet more preferably a hydrogen atom, a linear alkyl group having 1 or more and 3 or less carbon atoms, or a branched alkyl group having 1 or more and 3 or less carbon atoms, and particularly preferably a hydrogen atom.

The dicarboxylic acid unit (D) may be a constitutional unit represented by formula (D′) below.

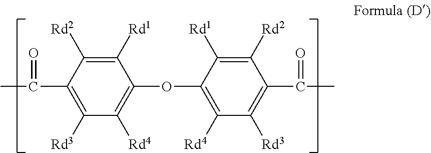

Rd¹, Rd², Rd³, and Rd⁴ in formula (D′) have the same definitions as Rd¹, Rd², Rd³, and Rd⁴ in formula (D), and preferable groups are also the same.

The dicarboxylic acid unit (D) is particularly preferably a diphenyl ether-4,4′-dicarboxylic acid unit (unit (D-1) below).

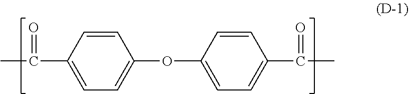

There may be one or more than one dicarboxylic acid units (D) contained in the polyarylate resin.

When the polyarylate resin has a dicarboxylic acid unit (D), the mass ratio of the dicarboxylic acid unit (D) in the polyarylate resin may be 1 mass % or more and 20 mass % or less.

Examples of other dicarboxylic acid units include aliphatic dicarboxylic acid (for example, oxalic acid, malonic acid, maleic acid, fumaric acid, citraconic acid, itaconic acid, glutaconic acid, succinic acid, alkenylsuccinic acid, adipic acid, and sebacic acid) units, alicyclic dicarboxylic acid (for example, cyclohexane dicarboxylic acid) units, and lower (for example, having 1 or more and 5 or less carbon atoms) alkyl ester units thereof. There may be one or more than one dicarboxylic acid units contained in the polyarylate resin.

The polyarylate resin may include diol units other than the diol unit (B).

Examples of other diol units include diol units (E) represented by formula (E) below.

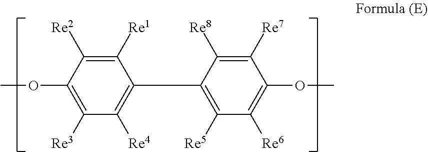

In formula (E), Re¹, Re², Re³, Re⁴, Re⁵, Re⁶, Re⁷, and Re⁸ are each independently a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms.

In formula (E), the alkyl group having 1 or more and 10 or less carbon atoms may be linear, branched, or cyclic. The number of carbon atoms in the alkyl group is preferably 1 or more and 6 or less, more preferably 1 or more and 4 or less, and yet more preferably 1 or 2.

In formula (E), the aryl group having 6 or more and 12 or less carbon atoms may be monocyclic or polycyclic. The number of carbon atoms in the aryl group is preferably 6 or more and 10 or less and more preferably 6 or more and 9 or less.

In formula (E), the aryl group in the aralkyl group having 7 or more and 20 or less carbon atoms may be monocyclic or polycyclic, and the alkyl group in the aralkyl group having 7 or more and 20 or less carbon atoms may be linear, branched, or cyclic. The number of carbon atoms in the aryl group is preferably 6 or more and 10 or less and more preferably 6 or more and 9 or less. The number of carbon atoms in the alkyl group is preferably 1 or more and 6 or less, more preferably 1 or more and 5 or less, and yet more preferably 1 or more and 4 or less.

In formula (E), the alkyl group in the alkoxy group having 1 or more and 6 or less carbon atoms may be linear, branched, or cyclic. The number of carbon atoms in the alkyl group in the alkoxy group having 1 or more and 6 or less carbon atoms is preferably 1 or more and 4 or less, more preferably 1 or more and 3 or less, and yet more preferably 1 or 2.

Implementation examples of the alkyl group, the aryl group, the aralkyl group, and the alkoxy group in formula (E) are the same as those groups described for formula (B).

In formula (E), Re¹, Re², Re³, Re⁴, Re⁵, Re⁶, Re⁷, and Re⁸ are preferably each independently a hydrogen atom, a linear alkyl group having 1 or more and 6 or less carbon atoms, or a branched alkyl group having 1 or more and 6 or less carbon atoms, more preferably a hydrogen atom, a linear alkyl group having 1 or more and 4 or less carbon atoms, or a branched alkyl group having 1 or more and 4 or less carbon atoms, yet more preferably a hydrogen atom, a linear alkyl group having 1 or more and 3 or less carbon atoms, or a branched alkyl group having 1 or more and 3 or less carbon atoms, and particularly preferably a hydrogen atom or a methyl group.

The diol unit (E) may be a constitutional unit represented by formula (E′) below.

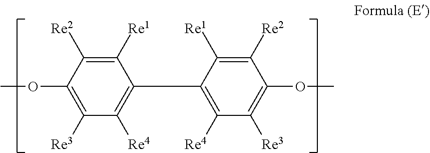

Re¹, Re², Re³, and Re⁴ in formula (E′) have the same definitions as Re¹, Re², Re³, and Re⁴ in formula (E), and preferable groups are also the same.

The diol unit (E) is particularly preferably one of units (E-1), (E-2), and (E-3) below.

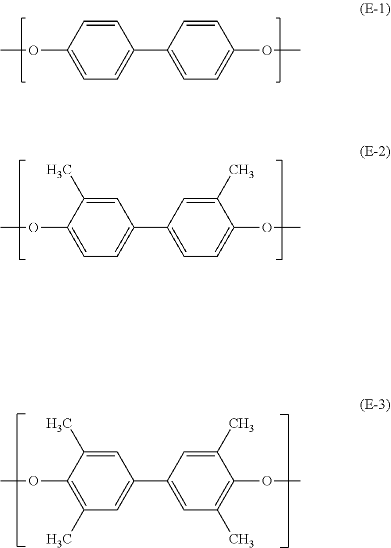

There may be one or more than one diol units (E) contained in the polyarylate resin.

When the polyarylate resin has a diol unit (E), the mass ratio of the diol unit (E) in the polyarylate resin may be 1 mass % or more and 20 mass % or less.

Examples of other diol units include diol units (F) represented by formula (F) below.

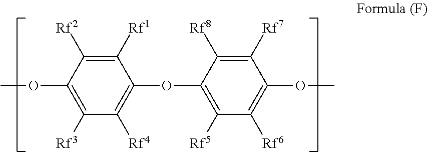

In formula (F), Rf¹, Rf², Rf³, Rf⁴, Rf⁵, Rf⁶, Rf⁷, and Rf⁸ are each independently a hydrogen atom, an alkyl group having 1 or more and 10 or less carbon atoms, an aryl group having 6 or more and 12 or less carbon atoms, an aralkyl group having 7 or more and 20 or less carbon atoms, or an alkoxy group having 1 or more and 6 or less carbon atoms.

In formula (F), the alkyl group having 1 or more and 10 or less carbon atoms may be linear, branched, or cyclic. The number of carbon atoms in the alkyl group is preferably 1 or more and 6 or less, more preferably 1 or more and 4 or less, and yet more preferably 1 or 2.

In formula (F), the aryl group having 6 or more and 12 or less carbon atoms may be monocyclic or polycyclic. The number of carbon atoms in the aryl group is preferably 6 or more and 10 or less and more preferably 6 or more and 9 or less.

In formula (F), the aryl group in the aralkyl group having 7 or more and 20 or less carbon atoms may be monocyclic or polycyclic, and the alkyl group in the aralkyl group having 7 or more and 20 or less carbon atoms may be linear, branched, or cyclic. The number of carbon atoms in the aryl group is preferably 6 or more and 10 or less and more preferably 6 or more and 9 or less. The number of carbon atoms in the alkyl group is preferably 1 or more and 6 or less, more preferably 1 or more and 5 or less, and yet more preferably 1 or more and 4 or less.

In formula (F), the alkyl group in the alkoxy group having 1 or more and 6 or less carbon atoms may be linear, branched, or cyclic. The number of carbon atoms in the alkyl group in the alkoxy group having 1 or more and 6 or less carbon atoms is preferably 1 or more and 4 or less, more preferably 1 or more and 3 or less, and yet more preferably 1 or 2.

Implementation examples of the alkyl group, the aryl group, the aralkyl group, and the alkoxy group in formula (F) are the same as those groups described for formula (B).

In formula (F), Rf¹, Rf², Rf³, Rf⁴, Rf⁵, Rf⁶, Rf⁷, and Rf⁸ are preferably each independently a hydrogen atom, a linear alkyl group having 1 or more and 6 or less carbon atoms, or a branched alkyl group having 1 or more and 6 or less carbon atoms, more preferably a hydrogen atom, a linear alkyl group having 1 or more and 4 or less carbon atoms, or a branched alkyl group having 1 or more and 4 or less carbon atoms, yet more preferably a hydrogen atom, a linear alkyl group having 1 or more and 3 or less carbon atoms, or a branched alkyl group having 1 or more and 3 or less carbon atoms, and particularly preferably a hydrogen atom or a methyl group.

The diol unit (F) may be a constitutional unit represented by formula (F′) below.

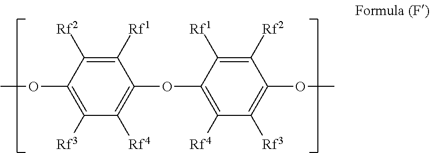

Rf¹, Rf², Rf³, and Rf⁴ in formula (F′) have the same definitions as Rf¹, Rf², Rf³, and Rf⁴ in formula (F), and preferable groups are also the same.

The diol unit (F) is particularly preferably a bis(4-hydroxyphenyl) ether unit (unit (F-1) below).

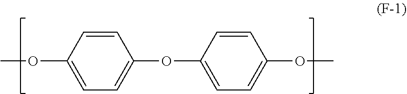

There may be one or more than one diol units (F) contained in the polyarylate resin.

When the polyarylate resin has a diol unit (F), the mass ratio of the diol unit (F) in the polyarylate resin may be 1 mass % or more and 20 mass % or less.

Examples of other diol units include aliphatic diol (for example, ethylene glycol, diethylene glycol, triethylene glycol, propylene glycol, butanediol, hexanediol, and neopentyl glycol) units and alicyclic diol (for example, cyclohexanediol, cyclohexanedimethanol, and hydrogenated bisphenol A) units. There may be one or more than one these diol units contained in the polyarylate resin.

The polyester resin containing the polyarylate resin is obtained by, for example, a typical polycondensation method using a monomer that gives a dicarboxylic acid unit, a monomer that gives a diol unit, and, if necessary, other monomers. Examples of the method for polycondensing monomers include an interfacial polymerization method, a solution polymerization method, and a melt polymerization method. The interfacial polymerization method is a polymerization method for obtaining a polyester by mixing dicarboxylic acid halide dissolved in an organic solvent incompatible with water and a dihydric alcohol dissolved in an alkaline aqueous solution. The interfacial polymerization method offers a reaction speed faster than the solution polymerization method, and thus, hydrolysis of dicarboxylic acid halide can be reduced, and a polyester resin with a high molecular weight is obtained as a result.

Terminals of the polyester resin containing the polyarylate resin may be capped or modified with a terminal capping agent or a molecular weight adjusting agent used during production. Examples of the terminal capping agent and the molecular weight adjusting agent include monohydric phenols, monoacid chlorides, monohydric alcohols, and monocarboxylic acids.

Examples of the monohydric phenol include phenol, o-cresol, m-cresol, p-cresol, o-ethylphenol, m-ethylphenol, p-ethylphenol, o-propylphenol, m-propylphenol, p-propylphenol, o-tert-butylphenol, m-tert-butylphenol, p-tert-butylphenol, pentylphenol, hexylphenol, octylphenol, nonylphenol, 2,6-dimethylphenol derivatives, 2-methylphenol derivatives, o-phenylphenol, m-phenylphenol, p-phenylphenol, o-methoxyphenol, m-methoxyphenol, p-methoxyphenol, 2,3,6-trimethylphenol, 2,3-xylenol, 2,4-xylenol, 2,5-xylenol, 2,6-xylenol, 3,4-xylenol, 3,5-xylenol, 2-phenyl-2-(4-hydroxyphenyl) propane, 2-phenyl-2-(2-hydroxyphenyl) propane, and 2-phenyl-2-(3-hydroxyphenyl) propane.

Examples of the monoacid chloride include monofunctional acid halides such as benzoyl chloride, benzoic acid chloride, methanesulfonyl chloride, phenyl chloroformate, acetic acid chloride, butyric acid chloride, octylic acid chloride, benzenesulfonyl chloride, benzenesulfinyl chloride, sulfinyl chloride, benzenephosphonyl chloride, and substitution products thereof.

Examples of the monohydric alcohol include methanol, ethanol, n-propanol, isopropanol, n-butanol, 2-butanol, pentanol, hexanol, dodecyl alcohol, stearyl alcohol, benzyl alcohol, and phenethyl alcohol.

Examples of the monocarboxylic acid include acetic acid, propionic acid, octanoic acid, cyclohexanecarboxylic acid, benzoic acid, toluic acid, phenylacetic acid, p-tert-butylbenzoic acid, and p-methoxyphenylacetic acid.

### Polycarbonate Resin

A known polycarbonate resin is used as the polycarbonate resin, and examples thereof include polycarbonate resins that include constitutional units having at least one of a biphenyl skeleton and a bisphenol skeleton (hereinafter this resin is also referred to as a “BP polycarbonate resin”).

Examples of the BP polycarbonate resin include homopolymers constituted by constitutional units having biphenyl skeletons, homopolymers constituted by constitutional units having bisphenol skeletons, and copolymers containing at least one of the constitutional units having biphenyl skeletons and constitutional units having bisphenol skeletons. The BP polycarbonate resin may be a homopolymer constituted by a constitutional unit having a bisphenol skeleton from the viewpoint of wear resistance.

Examples of the bisphenol skeleton include a bisphenol A skeleton, a bisphenol B skeleton, a bisphenol BP skeleton, a bisphenol C skeleton, a bisphenol F skeleton, and a bisphenol Z skeleton.

Specific examples of the BP polycarbonate resin include a homopolymer of a dihydroxybiphenyl compound, a homopolymer of a dihydroxybisphenol compound, and a copolymer thereof. These polymers are obtained by, for example, using the aforementioned compounds as the starting material by a method such as polycondensation with a carbonic ester-forming compound such as phosgene or a transesterification with a bisaryl carbonate.

The dihydroxybiphenyl compound is a biphenyl compound having a biphenyl skeleton in which each of the two benzene rings in the biphenyl skeleton has one hydroxyl group. Examples of the dihydroxybiphenyl compound include 4,4′-dihydroxybiphenyl, 4,4′-dihydroxy-3,3′-dimethylbiphenyl, 4,4′-dihydroxy-2,2′-dimethylbiphenyl, 4,4′-dihydroxy-3,3′-dicyclohexylbiphenyl, 3,3′-difluoro-4,4′-dihydroxybiphenyl, and 4,4′-dihydroxy-3,3′-diphenylbiphenyl.

These dihydroxybiphenyl compounds may be used alone or in combination.

The dihydroxybisphenol compound is a bisphenol compound having a bisphenol skeleton in which each of the two benzene rings in the bisphenol skeleton has one hydroxyl group. Examples of the dihydroxybisphenol compound include bis(4-hydroxyphenyl) methane, 1,1-bis(4-hydroxyphenyl) ethane, 1,2-bis(4-hydroxyphenyl) ethane, 2,2-bis(4-hydroxyphenyl) propane, 2,2-bis(3-methyl-4-hydroxyphenyl) butane, 2,2-bis(4-hydroxyphenyl) butane, 2,2-bis(4-hydroxyphenyl) octane, 4,4-bis(4-hydroxyphenyl) heptane, 1,1-bis(4-hydroxyphenyl)-1,1-diphenylmethane, 1,1-bis(4-hydroxyphenyl)-1-phenylethane, 1,1-bis(4-hydroxyphenyl)-1-phenylmethane, bis(4-hydroxyphenyl) ether, bis(4-hydroxyphenyl) sulfide, bis(4-hydroxyphenyl) sulfone, 1,1-bis(4-hydroxyphenyl)cyclopentane, 1,1-bis(4-hydroxyphenyl)cyclohexane, 2,2-bis(3-methyl-4-hydroxyphenyl) propane, 2-(3-methyl-4-hydroxyphenyl)-2-(4-hydroxyphenyl)-1-phenylethane, bis(3-methyl-4-hydroxyphenyl) sulfide, bis(3-methyl-4-hydroxyphenyl) sulfone, bis(3-methyl-4-hydroxyphenyl) methane, 1,1-bis(3-methyl-4-hydroxyphenyl)cyclohexane, 2,2-bis(2-methyl-4-hydroxyphenyl) propane, 1,1-bis(2-butyl-4-hydroxy-5-methylphenyl) butane, 1,1-bis(2-tert-butyl-4-hydroxy-3-methylphenyl) ethane, 1, 1-bis(2-tert-butyl-4-hydroxy-5-methylphenyl) propane, 1,1-bis(2-tert-butyl-4-hydroxy-5-methylphenyl) butane, 1,1-bis(2-tert-butyl-4-hydroxy-5-methylphenyl) isobutane, 1,1-bis(2-tert-butyl-4-hydroxy-5-methylphenyl) heptane, 1,1-bis(2-tert-butyl-4-hydroxy-5-methylphenyl)-1-phenylmethane, 1,1-bis(2-tert-amyl-4-hydroxy-5-methylphenyl) butane, bis(3-chloro-4-hydroxyphenyl) methane, bis(3,5-dibromo-4-hydroxyphenyl) methane, 2,2-bis(3-chloro-4-hydroxyphenyl) propane, 2,2-bis(3-fluoro-4-hydroxyphenyl) propane, 2,2-bis(3-bromo-4-hydroxyphenyl) propane, 2,2-bis(3,5-difluoro-4-hydroxyphenyl) propane, 2,2-bis(3,5-dichloro-4-hydroxyphenyl) propane, 2,2-bis(3,5-dibromo-4-hydroxyphenyl) propane, 2,2-bis(3-bromo-4-hydroxy-5-chlorophenyl) propane, 2,2-bis(3,5-dichloro-4-hydroxyphenyl) butane, 2,2-bis(3,5-dibromo-4-hydroxyphenyl) butane, 1-phenyl-1,1-bis(3-fluoro-4-hydroxyphenyl) ethane, bis(3-fluoro-4-hydroxyphenyl) ether, and 1,1-bis(3-cyclohexyl-4-hydroxyphenyl)cyclohexane.

These bisphenol compounds may be used alone or in combination.

From the viewpoint of wear resistance, the BP polycarbonate resin may be a polycarbonate resin containing at least one of a constitutional unit represented by formula (PCA) below and a constitutional unit represented by formula (PCB) below among these polycarbonate resins. In other words, examples of the BP polycarbonate resin include a homopolymer constituted by a constitutional unit represented by formula (PCA) below, a homopolymer constituted by a constitutional unit represented by formula (PCB) below, and a copolymer of these.

In particular, from the viewpoint of wear resistance, the BP polycarbonate resin is particularly preferably a polycarbonate resin containing a constitutional unit represented by formula (PCA) below.

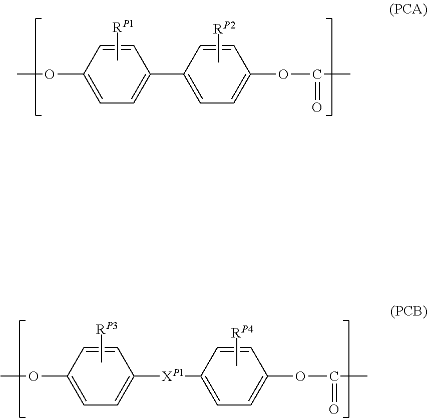

In formulae (PCA) and (PCB), R^{P1}, R^{P2}, R^{P3}, and R^{P4} are each independently a hydrogen atom, a halogen atom, an alkyl group having 1 or more and 6 or less carbon atoms, a cycloalkyl group having 5 or more and 7 or less carbon atoms, or an aryl group having 6 or more and 12 or less carbon atoms. X^{P1} represents a phenylene group, a biphenylylene group, a naphthylene group, an alkylene group, or a cycloalkylene group.

Examples of the alkyl group represented by R^{P1}, R^{P2}, R^{P3}, and R^{P4} in formulae (PCA) and (PCB) include linear or branched alkyl groups having 1 or more and 6 or less carbon atoms (preferably 1 or more and 3 or less carbon atoms).

Specific examples of the linear alkyl group include a methyl group, an ethyl group, an n-propyl group, an n-butyl group, an n-pentyl group, and an n-hexyl group.

Specific examples of the branched alkyl group include an isopropyl group, an isobutyl group, a sec-butyl group, a tert-butyl group, an isopentyl group, a neopentyl group, a tert-pentyl group, an isohexyl group, a sec-hexyl group, and a tert-hexyl group.

Among these lower alkyl groups such as a methyl group and an ethyl group are preferable as the alkyl group.

Examples of the cycloalkyl group represented by R^{P1}, R^{P2}, R^{P3}, and R^{P4} in formulae (PCA) and (PCB) include cyclopentyl, cyclohexyl, and cycloheptyl.

Examples of the aryl group represented by R^{P1}, R^{P2}, R^{P3}, and R^{P4} in formulae (PCA) and (PCB) include a phenyl group, a naphthyl group, and a biphenylyl group.

Examples of the alkylene group represented by X^{P1} in formula (PCB) include linear or branched alkylene groups having 1 or more and 12 or less carbon atoms (preferably 1 or more and 6 or less carbon atoms and more preferably 1 or more and 3 or less carbon atoms).

Specific examples of the linear alkylene group include a methylene group, an ethylene group, an n-propylene group, an n-butylene group, an n-pentylene group, an n-hexylene group, an n-heptylene group, an n-octylene group, an n-nonylene group, an n-decylene group, an n-undecylene group, and an n-dodecylene group.

Specific examples of the branched alkylene group include an isopropylene group, an isobutylene group, a sec-butylene group, a tert-butylene group, an isopentylene group, a neopentylene group, a tert-pentylene group, an isohexylene group, a sec-hexylene group, a tert-hexylene group, an isoheptylene group, a sec-heptylene group, a tert-heptylene group, an isooctylene group, a sec-octylene group, a tert-octylene group, an isononylene group, a sec-nonylene group, a tert-nonylene group, an isodecylene group, a sec-decylene group, a tert-decylene group, an isoundecylene group, a sec-undecylene group, a tert-undecylene group, a neoundecylene group, an isododecylene group, a sec-dodecylene group, a tert-dodecylene group, and a neododecylene group.

Among these, lower alkylene groups such as a methylene group, an ethylene group, and a butylene group are preferable as the alkylene group.

Examples of the cycloalkylene group represented by X^{P1} in formula (PCB) include cycloalkylene groups having 3 or more and 12 or less carbon atoms (preferably 3 or more and 10 or less carbon atoms and more preferably 5 or more and 8 or less carbon atoms).

Specific examples of the cycloalkylene group include a cyclopropylene group, a cyclopentylene group, a cyclohexylene group, a cyclooctylene cyclooctylene group, and a cyclododecanylene group.

Among these, a cyclohexylene group is preferable as the cycloalkylene group.

The aforementioned substituents represented by R^{P1}, R^{P2}, R^{P3}, R^{P4}, and X^{P1} in formulae (PCA) and (PCB) each further include a group having a substituent. Examples of such a substituent include a halogen atom (for example, a fluorine atom and a chlorine atom), an alkyl group (for example, an alkyl group having 1 or more and 6 or less carbon atoms), a cycloalkyl group (for example, a cycloalkyl group having 5 or more and 7 or less carbon atoms), an alkoxy group (for example, an alkoxy group having 1 or more and 4 or less carbon atoms), and an aryl group (for example, a phenyl group, a naphthyl group, and a biphenylyl group).

R^{P1} and R^{P2} in formula (PCA) preferably each independently represent a hydrogen atom or an alkyl group having 1 or more and 6 or less carbon atoms and more preferably each independently represent a hydrogen atom.

In formula (PCB), R^{P3} and R^{P4} preferably each independently represent a hydrogen atom or an alkyl group having 1 or more and 6 or less carbon atoms, and X^{P1} preferably represents an alkylene group or a cycloalkylene group.

Specific examples of the BP polycarbonate resin include, but are not limited to, those described below. Note that, in the example compounds, pm and pn each represent a copolymerization ratio.

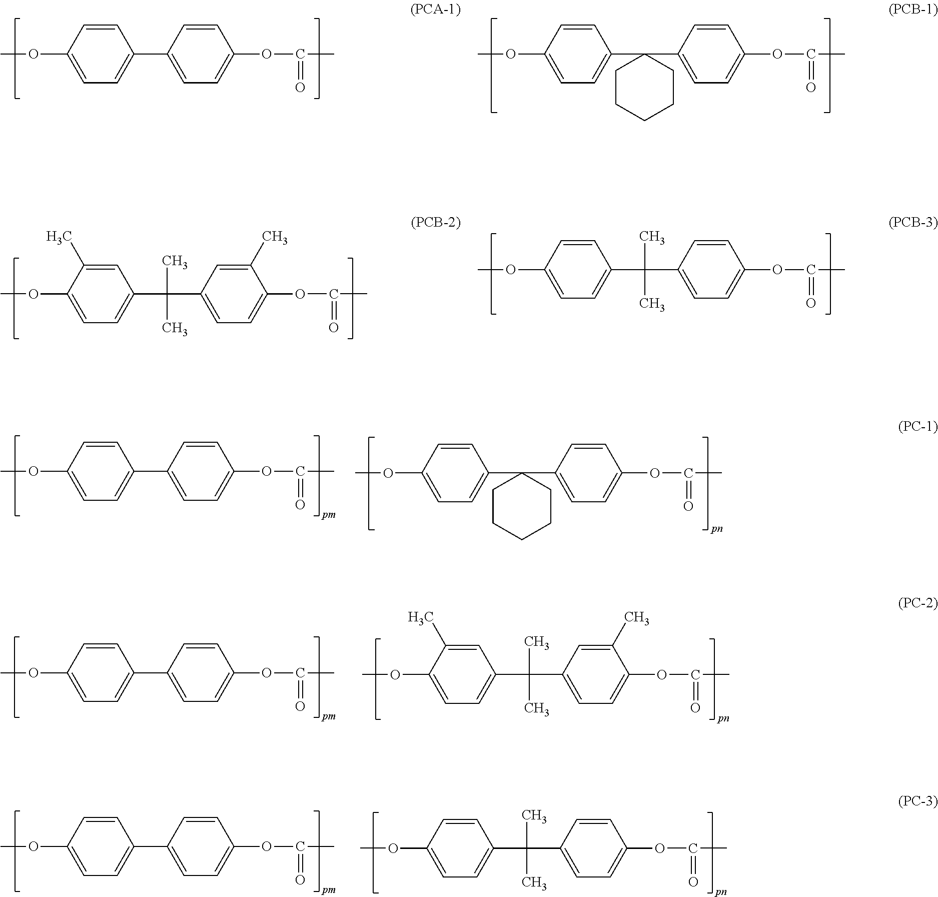

Here, in the polycarbonate resin, the content (copolymerization ratio) of the constitutional unit represented by formula (PCA) relative to all constitutional units constituting the polycarbonate resin is preferably in the range of 5 mol % or more and 95 mol % or less, more preferably in the range of 5 mol % or more and 50 mol % or less, and yet more preferably in the range of 15 mol % or more and 30 mol % or less from the viewpoint of the wear resistance.

Specifically, while pm and pn represent the copolymerization ratios (molar ratios) in the aforementioned example compounds of the polycarbonate resin, pm:pn=95:5 to 5:95, more preferably 50:50 to 5:95, and yet more preferably 15:85 to 30:70.

The single layer-type photosensitive layer contains a resin A and a resin B as the binder resin. The total content of the resin A and the resin B in the total content of the binder resin contained in the single layer-type photosensitive layer is preferably 50 mass % or more, more preferably 80 mass % or more, yet more preferably 90 mass % or more, particularly preferably 95 mass % or more, and most preferably 100 mass %.

### Hole Transport Material

The single layer-type photosensitive layer contains a hole transport material.

Examples of the hole transport material include hole transport compounds such as triarylamine compounds, benzidine compounds, arylalkane compounds, aryl-substituted ethylene compounds, stilbene compounds, anthracene compounds, and hydrazone compounds. These hole transport materials are used alone or in combination and are not limiting.

Examples of the polymer hole transport material include known compounds having a charge transporting property, such as poly-N-vinylcarbazole and polysilane. For example, a polyester polymer charge transport material is preferable. The polymer hole transport materials may be used alone or in combination with a binder resin.

Examples of the hole transport material or the polymer hole transport material include polycyclic aromatic compounds, aromatic nitro compounds, aromatic amine compounds, heterocyclic compounds, hydrazone compounds, styryl compounds, enamine compounds, benzidine compounds, triarylamine compounds (especially triphenylamine compounds), diamine compounds, oxadiazole compounds, carbazole compounds, organic polysilane compounds, pyrazoline compounds, indole compounds, oxazole compounds, isoxazole compounds, thiazole compounds, thiadiazole compounds, imidazole compounds, pyrazole compounds, triazole compounds, cyano compounds, benzofuran compounds, aniline compounds, butadiene compounds, and resins that have groups derived from these substances. Specific examples thereof are compounds described in Japanese Unexamined Patent Application Publication No. 2021-117377 (paragraphs 0078 to 0080), Japanese Unexamined Patent Application Publication No. 2019-035900 (paragraphs 0046 to 0048), Japanese Unexamined Patent Application Publication No. 2019-012141 (paragraphs 0052 to 0053), Japanese Unexamined Patent Application Publication No. 2021-071565 (paragraphs 0122 to 0134), Japanese Unexamined Patent Application Publication No. 2021-015223 (paragraphs 0101 to 0110), Japanese Unexamined Patent Application Publication No. 2013-097300 (paragraph 0116), International Publication No. 2019/070003 (paragraphs 0309 to 0316), Japanese Unexamined Patent Application Publication No. 2018-159087 (paragraphs 0103 to 0107), and Japanese Unexamined Patent Application Publication No. 2021-148818 (paragraphs 0102 to 0113).

From the viewpoint of charge mobility, the hole transport material preferably contains at least one compound selected from the group consisting of a compound (G1) represented by formula (G1) below, a compound (G2) represented by formula (G2) below, a compound (G3) represented by formula (G3) below, and a compound (G4) represented by formula (G4) below.

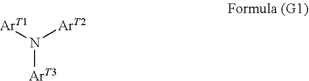

In formula (G1), Ar^{T1}, Ar^{T2}, and Ar^{T3} are each independently an aryl group, —C₆H₄—C(R^{T4})═C(R^{T5})(R^{T6}), or —C₆H₄—CH═CH—CH═C(R^{T7})(R^{T8}).

R^{T4}, R^{T5}, R^{T6}, R^{T7}, and R^{T8} are each independently a hydrogen atom, an alkyl group, or an aryl group.

When R^{T5} and R^{T6} are each an aryl group, these aryl groups may be linked via divalent groups, —C(R⁵¹) (R⁵²)— and/or —C(R⁶¹)═C(R⁶²)—. R⁵¹, R⁵², R⁶¹, and R⁶² are each independently a hydrogen atom or an alkyl group having 1 or more and 3 or less carbon atoms.

The groups in formula (G1) may each be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

From the viewpoint of the charge mobility, the compound (G1) is preferably a compound having at least one aryl group or —C₆H₄—CH═CH—CH═C(R^{T7})(R^{T8}) and is more preferably a compound (G′1) represented by formula (G′1) below.

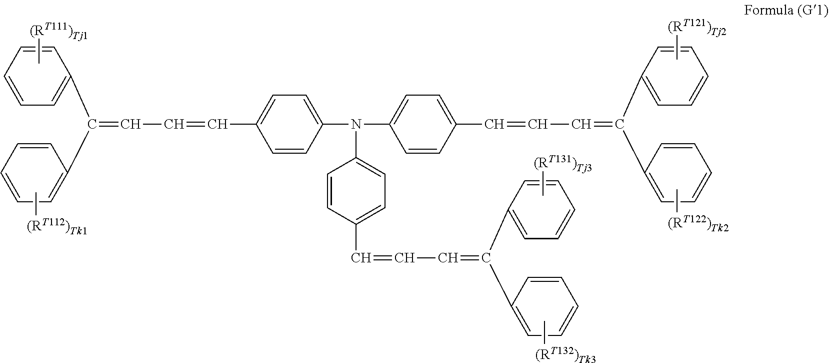

In formula (G′1), R^{T111}, R^{T112}, R^{T121}, R^{T122}, R^{T131}, and R^{T132} are each independently a hydrogen atom, a halogen atom, an alkyl group (preferably an alkyl group having 1 or more and 3 or less carbon atoms), an alkoxy group (preferably an alkoxy group having 1 or more and 3 or less carbon atoms), a phenyl group, or a phenoxy group. Tj1, Tj2, Tj3, Tk1, Tk2, and Tk3 are each independently 0, 1, or 2.

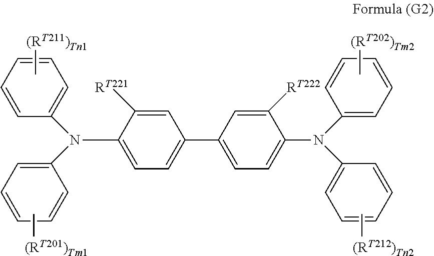

In formula (G2), R^{T201}, R^{T202}, R^{T211}, and R^{T212} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T21})═C(R^{T22})(R^{T23}), or —CH═CH—CH═C(R^{T24}) (R^{T25}). R^{T21}, R^{T22}, R^{T23}, R^{T24}, and R^{T25} are each independently a hydrogen atom, an alkyl group, or an aryl group. R^{T221} and R^{T222} are each independently a hydrogen atom, a halogen atom, an alkyl group having 1 or more and 5 or less carbon atoms, or an alkoxy group having 1 or more and 5 or less carbon atoms. Tm1, Tm2, Tn1, and Tn2 are each independently 0, 1, or 2.

The groups in formula (G2) may each be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

From the viewpoint of the charge mobility, the compound (G2) is preferably a compound having at least one alkyl group, aryl group, or —C⁶H⁴—CH═CH—CH═C(R^{T24})(R^{T25}) and is more preferably a compound having two alkyl groups, aryl groups, or CH═CH—CH═C(R^{T24})(R^{T25}).

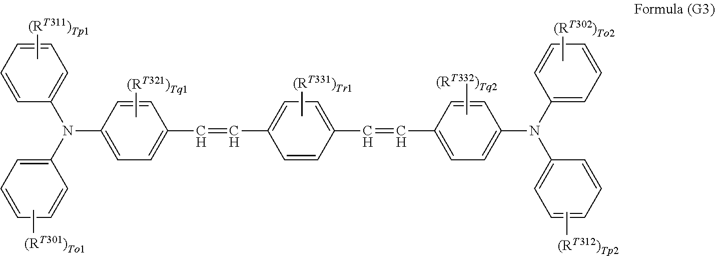

In formula (G3), R^{T301}, R^{T302}, R^{T311}, and R^{T312} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T31})—C(R^{T32})(R^{T33}), or —CH═CH—CH═C(R^{T34})(R^{T35}). R^{T31}, R^{T32}, R^{T33}, R^{T34}, and R^{T35} are each independently a hydrogen atom, an alkyl group, or an aryl group. R^{T321}, R^{T322}, and R^{T331} are each independently a hydrogen atom, a halogen atom, an alkyl group having 1 or more and 5 or less carbon atoms, or an alkoxy group having 1 or more and 5 or less carbon atoms. To1, To2, Tp1, Tp2, Tq1, Tq2, and Tr1 are each independently 0, 1, or 2.

The groups in formula (G3) may each be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

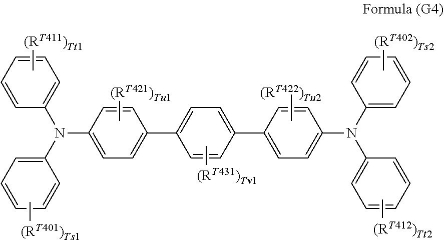

In formula (G4), R^{T401}, R^{T402}, R^{T411}, and R^{T412} are each independently a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T41})═C(R^{T42})(R^{T43}), or —CH═CH—CH—C(R^{T44})(R^{T45}). R^{T41}, R^{T42}, R^{T43}, R^{T44}, and R^{T45} are each independently a hydrogen atom, an alkyl group, or an aryl group. R^{T421}, R^{T422}, and R^{T431} are each independently a hydrogen atom, a halogen atom, an alkyl group having 1 or more and 5 or less carbon atoms, or an alkoxy group having 1 or more and 5 or less carbon atoms. Ts1, Ts2, Tt1, Tt2, Tu1, Tu2, and Tv1 are each independently 0, 1, or 2.

The groups in formula (G4) may each be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

The hole transport material content in the single layer-type photosensitive layer relative to the total mass of the single layer-type photosensitive layer may be 5 mass % or more and 50 mass % or less.

### Electron Transport Material

The single layer-type photosensitive layer contains an electron transport material.

Examples of the electron transport material include quinone compounds, for example, p-benzoquinone, chloranil, bromanil, and anthraquinone; tetracyanoquinodimethane compounds; fluorenone compounds such as 2,4,7-trinitrofluorenone; xanthone compounds; benzophenone compounds; cyanovinyl compounds; and ethylene compounds. These electron transport materials may be used alone or in combination.

From the viewpoints of sensitivity and the color spot generation reduction, the electron transport material preferably contains a compound represented by formula below and is more preferably a compound represented by formula (3) below.

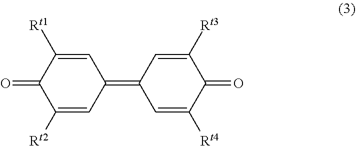

R^{t1} to R^{t4} each independently represent a hydrogen atom, an alkyl group, an alkoxy group, a cycloalkyl group, an aryl group, or an aralkyl group.

R^{t1} to R^{t4} are preferably each independently a hydrogen atom, an alkyl group having 1 or more and 12 or less carbon atoms, an alkoxy group having 1 or more and 12 or less carbon atoms, a cycloalkyl group, an aryl group, or an aralkyl group.

In addition, R^{t1} may be a group different from at least one of R^{t2} to R^{t4}.

From the viewpoints of sensitivity and the color spot generation reduction, R^{t1} and R^{t3} are preferably each independently an alkyl group having 3 or more and 12 or less carbon atoms, an alkoxy group having 3 or more and 12 or less carbon atoms, a cycloalkyl group, an aryl group, or an aralkyl group, more preferably a branched alkyl group having 3 or more and 12 or less carbon atoms, a branched alkoxy group having 3 or more and 12 or less carbon atoms, a cycloalkyl group, an aryl group, or an aralkyl group, yet more preferably a branched alkyl group having 3 or more and 8 or less carbon atoms or a branched alkoxy group having 3 or more and 8 or less carbon atoms, and particularly preferably a t-butyl group.

From the viewpoints of sensitivity and the color spot generation reduction, R^{t1} and R^{t3} are preferably the same group.

From the viewpoints of sensitivity and the color spot generation reduction, R^{t2} and R^{t4} are preferably each independently a hydrogen atom, an alkyl group having 1 or more and 8 or less carbon atoms, or an alkoxy group having 1 or more and 8 or less carbon atoms, more preferably a hydrogen atom, a linear alkyl group having 1 or more and 4 or less carbon atoms, or a linear alkoxy group having 1 or more and 4 or less carbon atoms, yet more preferably a linear alkyl group having 1 or more and 3 or less carbon atoms or a linear alkoxy group having 1 or more and 3 or less carbon atoms, and particularly preferably a methyl group.

From the viewpoints of sensitivity and the color spot generation reduction, R^{t2} and R^{t4} are preferably the same group.

From the viewpoints of sensitivity and the color spot generation reduction, R^{t1} and R^{t2} are preferably different groups and are preferably different from R^{t3} and R^{t4}.

From the viewpoints of sensitivity and the color spot generation reduction, the compound represented by formula (3) above is preferably a compound represented by formula (3-1) below.

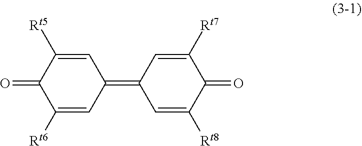

R^{t5} to R^{t8} in formula (3-1) each independently represent a hydrogen atom, an alkyl group having 1 or more and 12 or less carbon atoms, an alkoxy group having 1 or more and 12 or less carbon atoms, a cycloalkyl group, an aryl group, or an aralkyl group, and R^{t5} is different from at least one of R^{t6} to R^{t8}.

Preferable examples of R^{t5} to R^{t8} in formula (3-1) are the same as those of R^{t1} to R^{t4} in formula (3) except that the number of carbon atoms in the alkyl group and the alkoxy group in R^{t5} to R^{t8} is 1 or more and 12 and that R^{t5} is different from at least one of R^{t6} to R^{t8}.

Although example compounds of the electron transport material represented by formula (3) are described below, these example compounds are not limiting.

From the viewpoints of sensitivity and the color spot generation reduction, the electron transport material preferably contains example compounds 1 to 6, more preferably contains example compound 1, and most preferably is example compound 1.

| Example | | | | |
|---|---|---|---|---|
| compound | R¹ | R² | R³ | R⁴ |
| 1 | t-C₄H₉ | CH₃ | t-C₄H₉ | CH₃ |
| 2 | t-C₄H₉ | H | t-C₄H₉ | H |
| 3 | t-C₄H₉ | CH₃O | t-C₄H₉ | CH₃O |
| 4 | t-C₄H₉O | CH₃ | t-C₄H₉O | CH₃ |
| 5 | c-C₆H₁₁ | CH₃ | c-C₆H₁₁ | CH₃ |
| 6 | C₆H₅ | CH₃ | C₆H₅ | CH₃ |
| 7 | C₆H₅CH₂ | CH₃ | C₆H₅CH₂ | CH₃ |

Here, abbreviations etc., in the example compounds described above have the following meanings.
t-C₄H₉: t-butyl group
CH₃O: methoxy group
t-C₄H₉O: t-butoxy group
c-C₆H₁₁: cyclohexyl group
C₆H₅: phenyl group
C₆H₅CH₂: benzyl group

When a compound represented by formula (3) is used, it may be used in combination with electron transport materials other than those represented by formula (3). When a compound represented by formula (3) is used in combination with another electron transport material, the content of the compound represented by formula (3) may be 90 mass % or more with respect to the total amount of the electron transport materials.

Furthermore, from the viewpoint of increasing the sensitivity of the photosensitive layer, the electron transport material is preferably a fluorenone compound, and, of fluorenone compounds, a compound represented by formula (F2) is preferable.

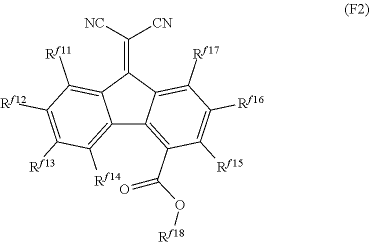

In formula (F2), R^{f11}, R^{f12}, R^{f13}, R^{f14}, R^{f15}, R^{f16}, and R^{f17} each independently represent a hydrogen atom, a halogen atom, an alkyl group, an alkoxy group, an aryl group, or an aralkyl group, and R^{f18} represents an alkyl group, an aryl group, an aralkyl group, or -L^{f19}-O—R^{f20} (where L^{f19} represents an alkylene group and R^{f20} represents an alkyl group).

Examples of the halogen atom represented by R^{f11} to R^{f17} in formula (F2) include a fluorine atom, a chlorine atom, a bromine atom, and an iodine atom, among which a fluorine atom and a chlorine atom are preferred and a chlorine atom is more preferred.

Examples of the alkyl group represented by R^{f11} to R^{f17} in formula (F2) include linear or branched alkyl groups having 1 or more and 20 or less carbon atoms (preferably 1 or more and 6 or less carbon atoms, more preferably 1 or more and 4 or less carbon atoms, and yet more preferably 1 or more and 3 or less carbon atoms). Examples of the linear alkyl group include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, an n-hexadecyl group, an n-heptadecyl group, an n-octadecyl group, an n-nonadecyl group, and an n-icosyl group. Examples of the branched alkyl group include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isoundecyl group, a sec-undecyl group, a tert-undecyl group, a neoundecyl group, an isododecyl group, a sec-dodecyl group, a tert-dodecyl group, a neododecyl group, an isotridecyl group, a sec-tridecyl group, a tert-tridecyl group, a neotridecyl group, an isotetradecyl group, a sec-tetradecyl group, a tert-tetradecyl group, a neotetradecyl group, a 1-isobutyl-4-ethyloctyl group, an isopentadecyl group, a sec-pentadecyl group, a tert-pentadecyl group, a neopentadecyl group, an isohexadecyl group, a sec-hexadecyl group, a tert-hexadecyl group, a neohexadecyl group, a 1-methylpentadecyl group, an isoheptadecyl group, a sec-heptadecyl group, a tert-heptadecyl group, a neoheptadecyl group, an isooctadecyl group, a sec-octadecyl group, a tert-octadecyl group, a neooctadecyl group, an isononadecyl group, a sec-nonadecyl group, a tert-nonadecyl group, a neononadecyl group, a 1-methyloctyl group, an isoicosyl group, a sec-icosyl group, a tert-icosyl group and a neoicosyl group. Among these, a methyl group and an ethyl group are preferable as the alkyl group.

Examples of the alkoxy group represented by R^{f11} to R^{f17} in formula (F2) include linear or branched alkoxy groups having 1 or more and 20 or less carbon atoms (preferably 1 or more and 6 or less carbon atoms, more preferably 1 or more and 4 or less carbon atoms, and yet more preferably 1 or more and 3 or less carbon atoms). Examples of the linear alkoxy group include a methoxy group, an ethoxy group, an n-propoxy group, an n-butoxy group, an n-pentyloxy group, an n-hexyloxy group, an n-heptyloxy group, an n-octyloxy group, an n-nonyloxy group, an n-decyloxy group, an n-undecyloxy group, an n-dodecyloxy group, an n-tridecyloxy group, an n-tetradecyloxy group, an n-pentadecyloxy group, an n-hexadecyloxy group, an n-heptadecyloxy group, an n-octadecyloxy group, an n-nonadecyloxy group, and an n-icosyloxy group. Examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, a tert-decyloxy group, an isoundecyloxy group, a sec-undecyloxy group, a tert-undecyloxy group, a neoundecyloxy group, an isododecyloxy group, a sec-dodecyloxy group, a tert-dodecyloxy group, a neododecyloxy group, an isotridecyloxy group, a sec-tridecyloxy group, a tert-tridecyloxy group, a neotridecyloxy group, an isotetradecyloxy group, a sec-tetradecyloxy group, a tert-tetradecyloxy group, a neotetradecyloxy group, a 1-isobutyl-4-ethyloctyloxy group, an isopentadecyloxy group, a sec-pentadecyloxy group, a tert-pentadecyloxy group, a neopentadecyloxy group, an isohexadecyloxy group, a sec-hexadecyloxy group, a tert-hexadecyloxy group, a neohexadecyloxy group, a 1-methylpentadecyloxy group, an isoheptadecyloxy group, a sec-heptadecyloxy group, a tert-heptadecyloxy group, a neoheptadecyloxy group, an isooctadecyloxy group, a sec-octadecyloxy group, a tert-octadecyloxy group, a neooctadecyloxy group, an isononadecyloxy group, a sec-nonadecyloxy group, a tert-nonadecyloxy group, a neononadecyloxy group, an 1-methyloctyloxy group, an isoicosyloxy group, a sec-icosyloxy group, a tert-icosyloxy group, and a neoicosyloxy group. Among these, a methoxy group is preferable as the alkoxy group.

Examples of the aryl group represented by R^{f11} to R^{f17} in formula (F2) include aryl groups having 6 or more and 30 or less carbon atoms (preferably 6 or more and 20 or less carbon atoms and more preferably 6 or more and 16 or less carbon atoms). Specific examples include a phenyl group, a biphenylyl group, a naphthyl group, and a phenanthryl group, among which a phenyl group and a naphthyl group are preferable. These aryl groups may each have 1 to 5 (preferably 1 or 2) substituents, and examples of such substituents include linear or branched alkyl groups having 1 or more and 4 or less carbon atoms (for example, a methyl group and an ethyl group); linear or branched alkoxy groups having 1 or more and 4 or less carbon atoms (for example, a methoxy group and an ethoxy group); and halogen atoms (for example, a fluorine atom and a chlorine atom).

Examples of the aralkyl group represented by R^{f11} to R^{f17} in formula (F2) include linear or branched alkylene groups having 1 or more and 6 or less carbon atoms (for example, a methylene group, an ethylene group, an n-propylene group, an isopropylene group, an n-butylene group, an isobutylene group, a sec-butylene group, a tert-butylene group, a pentylene group, and a hexylene group) with a group such as a phenyl group, a biphenylyl group, or a naphthyl group bonded thereto, among which a benzyl group and a phenethyl group are preferable. The benzene rings of these aralkyl groups may each have 1 to 5 (preferably 1 or 2) substituents, and examples of such substituents include linear or branched alkyl groups having 1 or more and 4 or less carbon atoms (for example, a methyl group and an ethyl group); linear or branched alkoxy groups having 1 or more and 4 or less carbon atoms (for example, a methoxy group and an ethoxy group); and halogen atoms (for example, a fluorine atom and a chlorine atom).

Examples of the alkyl group represented by R^{f18} in formula (F2) are the same as those of the alkyl group represented by R^{f11} to R^{f17}. The alkyl group represented by R^{f18} is preferably an alkyl group having 1 or more and 12 or less carbon atoms, more preferably an alkyl group having 4 or more and 10 or less carbon atoms, and yet more preferably a branched alkyl group having 5 or more and 10 or less carbon atoms.

Examples of the aryl group represented by R^{f18} in formula (F2) are the same as those of the aryl group represented by R^{f11} to R^{f17}. From the viewpoint of solubility in an organic solvent, the aryl group represented by R^{f18} is preferably an alkyl-substituted aryl group substituted with an alkyl group. The aryl group represented by R^{f18} is preferably a phenyl group, a methylphenyl group, a dimethylphenyl group, or an ethylphenyl group.

Examples of the aralkyl group represented by R^{f18} in formula (F2) are the same as those of the aralkyl group represented by R¹¹ to R¹⁷. From the viewpoint of solubility in an organic solvent, the aralkyl group represented by R^{f18} is preferably an alkyl-substituted aralkyl group substituted with an alkyl group. The aralkyl group represented by R^{f18} is preferably a benzyl group, a methylbenzyl group, a dimethylbenzyl group, or a phenethyl group.

In formula (F2), L^{f19} in-L^{f19}-O—R²⁰ (where L^{f19} represents an alkylene group and R^{f20} represents an alkyl group) represented by R^{f18} is, for example, a linear or branched alkylene group having 1 or more and 6 or less carbon atoms (for example, a methylene group, an ethylene group, an n-propylene group, an isopropylene group, an n-butylene group, an isobutylene group, a sec-butylene group, a tert-butylene group, a pentylene group, or a hexylene group), and examples of R^{f20} are the same as those for the alkyl group represented by R^{f11} to R^{f17}.

From the viewpoint of increasing the sensitivity of the photosensitive layer, the compound represented by formula (F2) may be a compound in which each of R^{f11} to R^{f17} independently represents a hydrogen atom, a halogen atom, or an alkyl group and R^{f18} represents an alkyl group having 4 or more and 10 or less carbon atoms.

Example compounds of the compound represented by formula (F2) are as follows. The compound represented by formula (F2) is not limited to these example compounds.

| Example | | | | | | | | |
|---|---|---|---|---|---|---|---|---|
| compound | R¹¹ | R¹² | R¹³ | R¹⁴ | R¹⁵ | R¹⁶ | R¹⁷ | R¹⁸ |
| 2-1 | H | H | H | H | H | H | H | -n-C₇H₁₅ |
| 2-2 | H | H | H | H | H | H | H | -n-C₈H₁₇ |
| 2-3 | H | H | H | H | H | H | H | -n-C₅H₁₁ |
| 2-4 | H | H | H | H | H | H | H | -n-C₁₀H₂₁ |
| 2-5 | Cl | Cl | Cl | Cl | Cl | Cl | Cl | -n-C₇H₁₅ |
| 2-6 | H | Cl | H | Cl | H | Cl | Cl | -n-C₇H₁₅ |
| 2-7 | CH₃ | CH₃ | CH₃ | CH₃ | CH₃ | CH₃ | CH₃ | -n-C₇H₁₅ |
| 2-8 | C₄H₉ | C₄H₉ | C₄H₉ | C₄H₉ | C₄H₉ | C₄H₉ | C₄H₉ | -n-C₇H₁₅ |
| 2-9 | OCH₃ | H | OCH₃ | H | OCH₃ | H | OCH₃ | -n-C₈H₁₇ |
| 2-10 | C₆H₅ | C₆H₅ | C₆H₅ | C₆H₅ | C₆H₅ | C₆H₅ | C₆H₅ | -n-C₈H₁₇ |
| 2-11 | H | H | H | H | H | H | H | -n-C₄H₉ |
| 2-12 | H | H | H | H | H | H | H | -n-C₁₁H₂₃ |
| 2-13 | H | H | H | H | H | H | H | -n-C₉H₁₉ |
| 2-14 | H | H | H | H | H | H | H | —CH₂—CH(C₂H₅)—C₄H₉ |
| 2-15 | H | H | H | H | H | H | H | —(CH₂)₂—C₆H₅ |
| 2-16 | H | H | H | H | H | H | H | —CH₂—C₆H₅ |
| 2-17 | H | H | H | H | H | H | H | -n-C₁₂H₂₅ |
| 2-18 | H | H | H | H | H | H | H | —C₂H₄—O—CH₃ |

The electron transport materials may be used alone or in combination.

The electron transport material content relative to the total mass of the photosensitive layer is preferably 5 mass % or more and 20 mass % or less, more preferably 10 mass % or more and 25 mass % or less, and yet more preferably 15 mass % or more and 20 mass % or less.

### Charge Generation Material

The single layer-type photosensitive layer contains a charge generation material.

Examples of the charge generation material include azo pigments such as bisazo and trisazo pigments; fused-ring aromatic pigments such as dibromoanthanthrone; perylene pigments; pyrrolopyrrole pigments; phthalocyanine pigments; zinc oxide; and trigonal selenium.

Among these, a metal phthalocyanine pigment or a metal-free phthalocyanine pigment may be used as the charge generation material in order to be used for near-infrared laser exposure. Specifically, for example, hydroxygallium phthalocyanine, chlorogallium phthalocyanine, dichlorotin phthalocyanine, and titanyl phthalocyanine are more preferable.

Meanwhile, for use with near-violet laser exposure, the charge generation material is preferably a fused-ring aromatic pigment such as dibromoanthanthrone, a thioindigo pigment, a porphyrazine compound, zinc oxide, trigonal selenium, a bisazo pigment, or the like.

When an incoherent light source, such as an LED or an organic EL image array having an emission center wavelength in the range of 450 nm or more and 780 nm or less, is used, the charge generation material described above may also be used.

When an n-type semiconductor, such as a fused-ring aromatic pigment, a perylene pigment, or an azo pigment, is used as the charge generation material, dark current rarely occurs and, even when the thickness is small, image defects known as black spots can be suppressed. The conductivity type is determined by a commonly practiced time-of-flight method by the polarity of the flowing photocurrent, and a material in which electrons rather than holes are likely to flow as a carrier is determined to be of an n-type.

The charge generation material content in the single layer-type photosensitive layer relative to the total mass of the single layer-type photosensitive layer may be 0.1 mass % or more and 10 mass % or less and more preferably 0.8 mass % or more and 5 mass % or less.

The single layer-type photosensitive layer may contain other known additives. Examples of the additives include an antioxidant, a leveling agent, a defoamer, a filler, and a viscosity adjustor.

The single layer-type photosensitive layer may be formed by any known method, for example, by forming a coating film with a single layer-type photosensitive layer-forming solution containing the aforementioned components and a solvent, drying the coating film, and, if necessary, heating the dried coating film.

The solvent used to prepare a single layer-type photosensitive layer-forming coating solution include typical organic solvents such as aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in combination as a mixture.

Examples of the method for applying the single layer-type photosensitive layer-forming solution include common methods such as a blade coating method, a wire bar coating method, a spray coating method, a dip coating method, a bead coating method, an air knife coating method, and a curtain coating method.

The average thickness of the single layer-type photosensitive layer is preferably 20 um or more and 50 μm or less, more preferably 25 μm or more and 45 μm or less, and yet more preferably 30 μm or more and 40 μm or less.

### Conductive Substrate

The positively chargeable electrophotographic photoreceptor of this exemplary embodiment may include a conductive substrate and a single layer-type photosensitive layer disposed on the conductive substrate.

Examples of the conductive substrate include metal plates, metal drums, and metal belts that contain metals (aluminum, copper, zinc, chromium, nickel, molybdenum, vanadium, indium, gold, platinum, etc.) or alloys (stainless steel etc.). Other examples of the conductive substrate include paper sheets, resin films, and belts coated, vapor-deposited, or laminated with conductive compounds (for example, conductive polymers and indium oxide), metals (for example, aluminum, palladium, and gold), or alloys. Here, “conductive” means having a volume resistivity of less than 1×10¹³ Ω·cm.

The surface of the conductive substrate may be roughened to a center-line average roughness Ra of 0.04 um or more and 0.5 μm or less in order to reduce interference fringes that occur when the electrophotographic photoreceptor used in a laser printer is irradiated with a laser beam. When incoherent light is used as a light source, there is no need to roughen the surface to reduce interference fringes, but roughening the surface reduces generation of defects due to irregularities on the surface of the conductive substrate and thus is desirable for extending the lifetime.

Examples of the surface roughening method include a wet honing method with which an abrasive suspended in water is sprayed onto a conductive substrate, a centerless grinding with which a conductive substrate is pressed against a rotating grinding stone to perform continuous grinding, and an anodization treatment.

Another example of the surface roughening method does not involve roughening the surface of a conductive substrate but involves dispersing a conductive or semi-conductive powder in a resin and forming a layer of the resin on a surface of a conductive substrate so as to create a rough surface by the particles dispersed in the layer.

The surface roughening treatment by anodization involves forming an oxide film on the surface of a conductive substrate by anodization by using a metal (for example, aluminum) conductive substrate as the anode in an electrolyte solution. Examples of the electrolyte solution include a sulfuric acid solution and an oxalic acid solution. However, a porous anodization film formed by anodization is chemically active as is, is prone to contamination, and has resistivity that is highly variable depending on the environment. Thus, a pore-sealing treatment may be performed on the porous anodization film so as to seal fine pores in the oxide film by volume expansion caused by hydrating reaction in pressurized steam or boiling water (a metal salt such as a nickel salt may be added) so that the oxide is converted into a more stable hydrous oxide.

The thickness of the anodization film may be, for example, 0.3 μm or more and 15 μm or less. When the thickness is within this range, a barrier property against injection tends to be exhibited, and the increase in residual potential caused by repeated use tends to be reduced.

The conductive substrate may be subjected to a treatment with an acidic treatment solution or a Boehmite treatment.

The treatment with an acidic treatment solution is, for example, conducted as follows. First, an acidic treatment solution containing phosphoric acid, chromic acid, and hydrofluoric acid is prepared. The blend ratios of phosphoric acid, chromic acid, and hydrofluoric acid in the acidic treatment solution may be, for example, in the range of 10 mass % or more and 11 mass % or less for phosphoric acid, in the range of 3 mass % or more and 5 mass % or less for chromic acid, and in the range of 0.5 mass % or more and 2 mass % or less for hydrofluoric acid; and the total concentration of these acids may be in the range of 13.5 mass % or more and 18 mass % or less. The treatment temperature may be, for example, 42° C. or higher and 48° C. or lower. The thickness of the film may be 0.3 μm or more and 15 μm or less.

The Boehmite treatment is conducted by immersing a conductive substrate in pure water at 90° C. or higher and 100° C. or lower for 5 to 60 minutes or by bringing a conductive substrate into contact with pressurized steam at 90° C. or higher and 120° C. or lower for 5 to 60 minutes. The thickness of the film may be 0.1 μm or more and 5 μm or less. The Boehmite-treated substrate may be further anodized by using an electrolyte solution, such as adipic acid, boric acid, a borate salt, a phosphate salt, a phthalate salt, a maleate salt, a benzoate salt, a tartrate salt, or a citrate salt, that has low film-dissolving power.

### Undercoat Layer

The positively chargeable electrophotographic photoreceptor of this exemplary embodiment may include an undercoat layer between the conductive substrate and the single layer-type photosensitive layer.

The undercoat layer is a layer containing, for example, inorganic particles and a binder resin.

Examples of the inorganic particles include inorganic particles that have a powder resistance (volume resistivity) of 1×10² Ω·cm or more and 1×10¹¹ Ω·cm or less.

As the inorganic particles having this resistance value, for example, metal oxide particles such as tin oxide particles, titanium oxide particles, zinc oxide particles, or zirconium oxide particles are preferable, and zinc oxide particles are particularly preferable.

The specific surface area of the inorganic particles as measured by a BET method may be, for example, 10 m²/g or more.

The volume-average particle diameter of the inorganic particles may be, for example, 50 nm or more and 2000 nm or less (preferably 60 nm or more and 1000 nm or less).

The inorganic particle content relative to the binder resin is, for example preferably 10 mass % or more and 80 mass % or less and more preferably 40 mass % or more and 80 mass % or less.

The inorganic particles may be surface-treated. Two or more types of inorganic particles subjected to different surface treatments or having different particle sizes may be mixed and used.

Examples of the surface treatment agent include a silane coupling agent, a titanate coupling agent, an aluminum coupling agent, and a surfactant. In particular, a silane coupling agent is preferable, and an amino-group-containing silane coupling agent is more preferable.

Examples of the amino-group-containing silane coupling agent include, but are not limited to, 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane.

Two or more silane coupling agents may be mixed and used. For example, an amino-group-containing silane coupling agent may be used in combination with an additional silane coupling agent. Examples of this additional silane coupling agent include, but are not limited to, vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

The surface treatment method that uses a surface treatment agent may be any known method, for example, may be a dry method or a wet method.

The treatment amount of the surface treatment agent may be, for example, 0.5 mass % or more and 10 mass % or less relative to the inorganic particles.

Here, from the viewpoint of enhancing the long-term stability of electrical properties and the carrier-blocking properties, the undercoat layer may contain an electron-accepting compound (acceptor compound) along with the inorganic particles.

Examples of the electron-accepting compound include electron transport substances, such as quinone compounds such as chloranil and bromanil; tetracyanoquinodimethane compounds; fluorenone compounds such as 2,4,7-trinitrofluorenone and 2,4,5,7-tetranitro-9-fluorenone; oxadiazole compounds such as 2-(4-biphenyl)-5-(4-t-butylphenyl)-1,3,4-oxadiazole, 2,5-bis(4-naphthyl)-1,3,4-oxadiazole, and 2,5-bis(4-diethylaminophenyl)-1,3,4-oxadiazole; xanthone compounds; thiophene compounds; diphenoquinone compounds such as 3,3′,5,5′-tetra-t-butyldiphenoquinone; and benzophenone compounds.

In particular, a compound having an anthraquinone structure may be used as the electron-accepting compound. Examples of the compound having an anthraquinone structure include hydroxyanthraquinone compounds, aminoanthraquinone compounds, and aminohydroxyanthraquinone compounds, and more specific examples thereof include anthraquinone, alizarin, quinizarin, anthrarufin, and purpurin.

The electron-accepting compound may be dispersed in the undercoat layer along with the inorganic particles, or may be attached to the surfaces of the inorganic particles.

Examples of the method for attaching the electron-accepting compound onto the surfaces of the inorganic particles include a dry method and a wet method.

The dry method is, for example, a method with which, while inorganic particles are stirred with a mixer or the like having a large shear force, an electron-accepting compound as is or dissolved in an organic solvent is added dropwise or sprayed along with dry air or nitrogen gas so as to cause the electron-accepting compound to attach to the surfaces of the inorganic particles. When the electron-accepting compound is added dropwise or sprayed, the temperature may be equal to or lower than the boiling point of the solvent. After the electron-accepting compound is added dropwise or sprayed, baking may be further conducted at 100° C. or higher. The temperature and time for baking are not particularly limited as long as the electrophotographic properties are obtained.

The wet method is, for example, a method with which, while inorganic particles are dispersed in a solvent by stirring, ultrasonically, or by using a sand mill, an attritor, or a ball mill, the electron-accepting compound is added, followed by stirring or dispersing, and then the solvent is removed to cause the electron-accepting compound to attach to the surfaces of the inorganic particles. The solvent is removed by, for example, filtration or distillation. After removing the solvent, baking may be further conducted at 100° C. or higher. The temperature and time for baking are not particularly limited as long as the electrophotographic properties are obtained. In the wet method, the moisture contained in the inorganic particles may be removed before adding the electron-accepting compound; for example, the moisture may be removed by stirring and heating the inorganic particles in a solvent or by boiling together with the solvent.

The electron-accepting compound may be attached before, after, or at the same time as surface-treating the inorganic particles with a surface treatment agent.

The amount of the electron-accepting compound contained relative to the inorganic particles is, for example, preferably 0.01 mass % or more and 20 mass % or less, and is more preferably 0.01 mass % or more and 10 mass % or less.

Examples of the binder resin used in the undercoat layer include known materials such as known polymer compounds such as acetal resins (for example, polyvinyl butyral), polyvinyl alcohol resins, polyvinyl acetal resins, casein resins, polyamide resins, cellulose resins, gelatin, polyurethane resins, polyester resins, unsaturated polyester resins, methacrylic resins, acrylic resins, polyvinyl chloride resins, polyvinyl acetate resins, vinyl chloride-vinyl acetate-maleic anhydride resins, silicone resins, silicone-alkyd resins, urea resins, phenolic resins, phenol-formaldehyde resins, melamine resins, urethane resins, alkyd resins, and epoxy resins; zirconium chelate compounds; titanium chelate compounds; aluminum chelate compounds; titanium alkoxide compounds; organic titanium compounds; and silane coupling agents.

Other examples of the binder resin used in the undercoat layer include charge transport resins that have charge transport groups, and conductive resins (for example, polyaniline).

Among these, a resin that is insoluble in the coating solvent in the overlying layer is suitable as the binder resin used in the undercoat layer, and examples of the particularly suitable resin include thermosetting resins such as a urea resin, a phenolic resin, a phenol-formaldehyde resin, a melamine resin, a urethane resin, an unsaturated polyester resin, an alkyd resin, and an epoxy resin; and a resin obtained by a reaction between a curing agent and at least one resin selected from the group consisting of a polyamide resin, a polyester resin, a polyether resin, a methacrylic resin, an acrylic resin, a polyvinyl alcohol resin, and a polyvinyl acetal resin.

When two or more of these binder resins are used in combination, the mixing ratios are set as necessary.

The undercoat layer may contain various additives to improve electrical properties, environmental stability, and image quality.

Examples of the additives include known materials such as electron transporting pigments based on polycyclic condensed materials and azo materials, zirconium chelate compounds, titanium chelate compounds, aluminum chelate compounds, titanium alkoxide compounds, organic titanium compounds, and silane coupling agents. The silane coupling agent is used to surface-treat the inorganic particles as mentioned above, but may be further added as an additive to the undercoat layer.

Examples of the silane coupling agent that serves as an additive include vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compounds include zirconium butoxide, zirconium ethyl acetoacetate, zirconium triethanolamine, acetylacetonate zirconium butoxide, ethyl acetoacetate zirconium butoxide, zirconium acetate, zirconium oxalate, zirconium lactate, zirconium phosphonate, zirconium octanoate, zirconium naphthenate, zirconium laurate, zirconium stearate, zirconium isostearate, methacrylate zirconium butoxide, stearate zirconium butoxide, and isostearate zirconium butoxide.

Examples of the titanium chelate compounds include tetraisopropyl titanate, tetra-n-butyl titanate, butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compounds include aluminum isopropylate, monobutoxyaluminum diisopropylate, aluminum butyrate, ethylacetoacetate aluminum diisopropylate, and aluminum tris(ethylacetoacetate).

These additives may be used alone, or two or more compounds may be used as a mixture or a polycondensation product.

The undercoat layer may have a Vickers hardness of 35 or more.

In order to suppress moire images, the surface roughness (ten-point average roughness) of the undercoat layer may be adjusted to be in the range of 1/(4n) (n represents the refractive index of the overlying layer) to ½ of the laser wavelength λ used for exposure.

In order to adjust the surface roughness, resin particles and the like may be added to the undercoat layer. Examples of the resin particles include silicone resin particles and crosslinking polymethyl methacrylate resin particles. The surface of the undercoat layer may be polished to adjust the surface roughness. Examples of the polishing method include buff polishing, sand blasting, wet honing, and grinding.

The undercoat layer may be formed by any known method, for example, by forming a coating film with an undercoat-layer-forming solution containing the aforementioned components and a solvent, drying the coating film, and if necessary, heating the dried coating film.

Examples of the solvent used for preparing the undercoat layer-forming solution include known organic solvents, such as alcohol solvents, aromatic hydrocarbon solvents, halogenated hydrocarbon solvents, ketone solvents, ketone alcohol solvents, ether solvents, and ester solvents.

Specific examples of the solvent include common organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method for dispersing inorganic particles in preparing the undercoat layer-forming solution include known methods that use a roll mill, a ball mill, a vibrating ball mill, an attritor, a sand mill, a colloid mill, and a paint shaker.

Examples of the method for applying the undercoat layer-forming solution to the conductive substrate include common methods such as a blade coating method, a wire bar coating method, a spray coating method, a dip coating method, a bead coating method, an air knife coating method, and a curtain coating method.

The thickness of the undercoat layer is, for example, preferably 15 μm or more, and more preferably within the range of 20 μm or more and 50 μm or less.

### Intermediate Layer

The positively chargeable electrophotographic photoreceptor of this exemplary embodiment may further include an intermediate layer between the undercoat layer and the single layer-type photosensitive layer.

The intermediate layer is, for example, a layer that contains a resin. Examples of the resin used in the intermediate layer include polymer compounds such as acetal resins (for example, polyvinyl butyral), polyvinyl alcohol resins, polyvinyl acetal resins, casein resins, polyamide resins, cellulose resins, gelatin, polyurethane resins, polyester resins, methacrylic resins, acrylic resins, polyvinyl chloride resins, polyvinyl acetate resins, vinyl chloride-vinyl acetate-maleic anhydride resins, silicone resins, silicone-alkyd resins, phenol-formaldehyde resins, and melamine resins.

The intermediate layer may contain an organic metal compound. Examples of the organic metal compound used in the intermediate layer include organic metal compounds containing metal atoms such as zirconium, titanium, aluminum, manganese, and silicon.

These compounds used in the intermediate layer may be used alone, or two or more compounds may be used as a mixture or a polycondensation product.

In particular, the intermediate layer may be a layer that contains an organic metal compound that contains zirconium atoms or silicon atoms.

The intermediate layer may be formed by any known method, for example, by forming a coating film with an intermediate-layer-forming solution containing the aforementioned components and a solvent, drying the coating film, and, if necessary, heating the dried coating film.

Examples of the application method for forming the intermediate layer include common methods such as a dip coating method, a lift coating method, a wire bar coating method, a spray coating method, a blade coating method, an air knife coating method, and a curtain coating method.

The thickness of the intermediate layer may be set within the range of, for example, 0.1 μm or more and 3 μm or less. The intermediate layer may be used as the undercoat layer. Protection layer

A protection layer is disposed on the single layer-type photosensitive layer if necessary. The protection layer is provided for the purpose of preventing chemical changes in the photosensitive layer during charging and further improving the mechanical strength of the single layer-type photosensitive layer.

Thus, the protection layer may be a layer formed of a cured film (crosslinked film). Examples of such a layer are 1) and 2) below.

1) A layer composed of a cured film of a composition that contains a reactive group-containing hole transport material that has a reactive group and a hole transport skeleton in the same molecule (in other words, a layer that contains a polymer or crosslinked body of the reactive group-containing hole transport material)

2) A layer composed of a cured film of a composition that contains a non-reactive hole transport material and a reactive group-containing non-hole transport material that has no hole transport skeleton but has a reactive group (in other words, a layer that contains a polymer or crosslinked body of a non-reactive hole transport material and the reactive group-containing non-hole transport material)

Examples of the reactive group contained in the reactive group-containing hole transport material include known reactive groups such as chain-polymerizable groups, an epoxy group, —OH, —OR (where R represents an alkyl group), —NH₂, —SH, —COOH, —SiR^{Q1}_{3-Qn}(OR^{Q2})_{Qn} (where R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3).

The chain-polymerizable group may be any radical-polymerizable functional group, and an example thereof is a functional group having a group that contains at least a carbon-carbon double bond. A specific example thereof is a group that contains at least one selected from a vinyl group, a vinyl ether group, a vinyl thioether group, a phenylvinyl group, a vinylphenyl group, an acryloyl group, a methacryloyl group, and derivatives thereof. Among these, due to excellent reactivity, the chain-polymerizable group may be a group that contains at least one selected from a vinyl group, a phenylvinyl group, a vinylphenyl group, an acryloyl group, a methacryloyl group, and derivatives thereof.

The hole transport skeleton of the reactive group-containing hole transport material may be any known structure used in the electrophotographic photoreceptor, and examples thereof include skeletons that are derived from nitrogen-containing hole transport compounds, such as triarylamine compounds, benzidine compounds, and hydrazone compounds, and that are conjugated with nitrogen atoms. Among these, a triarylamine skeleton is preferable.

The reactive-group-containing hole transport material that has such a reactive group and a hole transport skeleton, the non-reactive hole transport material, and the reactive-group-containing non-hole transport material may be selected from among known materials.

The protection layer may contain other known additives.

The protection layer may be formed by any known method, for example, by forming a coating film with a protection layer-forming solution containing the aforementioned components and a solvent, drying the coating film, and, if necessary, curing the dried coating film such as by heating.

Examples of the solvent used to prepare the protection layer-forming solution include aromatic solvents such as toluene and xylene, ketone solvents such as methyl ethyl ketone, methyl isobutyl ketone, and cyclohexanone, ester solvents such as ethyl acetate and butyl acetate, ether solvents such as tetrahydrofuran and dioxane, cellosolve solvents such as ethylene glycol monomethyl ether, and alcohol solvents such as isopropyl alcohol and butanol. These solvents are used alone or in combination as a mixture.

The protection layer-forming solution may be a solvent-free solution.

Examples of the application method used to apply the protection layer-forming solution onto the photosensitive layer (for example, the charge transport layer) include common methods such as a dip coating method, a lift coating method, a wire bar coating method, a spray coating method, a blade coating method, an air knife coating method, and a curtain coating method.

The thickness of the protection layer is preferably set within the range of 1 μm or more and 20 μm or less, and more preferably within the range of 2 μm or more and 10 μm or less.

### Image Forming Apparatus and Process Cartridge

An image forming apparatus of an exemplary embodiment includes an electrophotographic photoreceptor, a charging device that charges a surface of the electrophotographic photoreceptor, an electrostatic latent image forming device that forms an electrostatic latent image on the charged surface of the electrophotographic photoreceptor, a developing device that develops the electrostatic latent image on the surface of the electrophotographic photoreceptor by using a developer that contains a toner so as to form a toner image, and a transfer device that transfers the toner image onto a surface of a recording medium, in which the charging device has a positive charging system. In addition, the positively chargeable electrophotographic photoreceptor according to an exemplary embodiment is applied as the electrophotographic photoreceptor.

The image forming apparatus of the exemplary embodiment is applied to a known image forming apparatus, examples of which include an apparatus equipped with a fixing device that fixes the toner image transferred onto the surface of the recording medium; a direct transfer type apparatus with which the toner image formed on the surface of the electrophotographic photoreceptor is directly transferred to the recording medium; an intermediate transfer type apparatus with which the toner image formed on the surface of the electrophotographic photoreceptor is first transferred to a surface of an intermediate transfer body and then the toner image on the surface of the intermediate transfer body is transferred to the surface of the recording medium; an apparatus equipped with a cleaning device that cleans the surface of the electrophotographic photoreceptor after the toner image transfer and before charging; an apparatus equipped with a charge erasing device that erases the charges on the surface of the electrophotographic photoreceptor by applying the charge erasing light after the toner image transfer and before charging; and an apparatus equipped with an electrophotographic photoreceptor heating member that elevates the temperature of the electrophotographic photoreceptor to reduce the relative temperature.

In the intermediate transfer type apparatus, the transfer device includes, for example, an intermediate transfer body having a surface onto which a toner image is to be transferred, a first transfer device that conducts first transfer of the toner image on the surface of the electrophotographic photoreceptor onto the surface of the intermediate transfer body, and a second transfer device that conducts second transfer of the toner image on the surface of the intermediate transfer body onto a surface of a recording medium.

The image forming apparatus of this exemplary embodiment may be of a dry development type or a wet development type (development type that uses a liquid developer).

In the image forming apparatus of the exemplary embodiment, for example, a section that includes the electrophotographic photoreceptor may be configured as a cartridge structure (process cartridge) detachably attachable to the image forming apparatus. A process cartridge equipped with the photoreceptor of the present exemplary embodiment may be used as this process cartridge. The process cartridge may include, in addition to the electrophotographic photoreceptor, at least one selected from the group consisting of a charging device, an electrostatic latent image forming device, a developing device, and a transfer device.

Although some examples of the image forming apparatus of the present exemplary embodiment are described below, these examples are not limiting. Only relevant parts illustrated in the drawings are described, and descriptions of other parts are omitted.

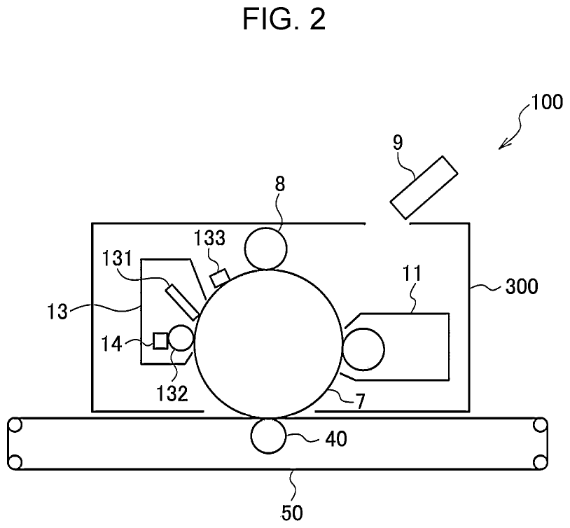

FIG. 2 is a schematic cross-sectional view of one example of an image forming apparatus according to one exemplary embodiment.

As illustrated in FIG. 2, an image forming apparatus 100 of this exemplary embodiment includes a process cartridge 300 equipped with an electrophotographic photoreceptor 7, an exposing device 9 (one example of the electrostatic latent image forming device), a transfer device 40 (first transfer device), and an intermediate transfer body 50. In this image forming apparatus 100, the exposing device 9 is positioned so that light can be applied to the electrophotographic photoreceptor 7 from the opening of the process cartridge 300, the transfer device 40 is positioned to oppose the electrophotographic photoreceptor 7 with the intermediate transfer body 50 therebetween, and the intermediate transfer body 50 has a portion in contact with the electrophotographic photoreceptor 7. Although not illustrated in the drawings, a second transfer device that transfers the toner image on the intermediate transfer body 50 onto a recording medium (for example, a paper sheet) is also provided. The intermediate transfer body 50, the transfer device 40 (first transfer device), and the second transfer device (not illustrated) correspond to examples of the transfer device.

The process cartridge 300 illustrated in FIG. 2 integrates and supports the electrophotographic photoreceptor 7, a charging device 8 (one example of the charging device), a developing device 11 (one example of the developing device), and a cleaning device 13 (one example of the cleaning device) in the housing. The cleaning device 13 has a cleaning blade (one example of the cleaning member) 131, and the cleaning blade 131 is in contact with the surface of the electrophotographic photoreceptor 7. The cleaning member may take a form other than the cleaning blade 131, and may be a conductive or insulating fibrous member that can be used alone or in combination with the cleaning blade 131.

Although an example of the image forming apparatus equipped with a fibrous member 132 (roll) that supplies a lubricant 14 to the surface of the electrophotographic photoreceptor 7 and a fibrous member 133 (flat brush) that assists cleaning is illustrated in FIG. 2, these members are optional.

The features of the image forming apparatus of this exemplary embodiment will now be described.

### Charging Device

The charging device 8 has a positive charging system.

The charging device 8 may be any charger that can perform positive charging, and examples thereof include contact-type chargers that use conductive or semi-conducting charging rollers, charging brushes, charging films, charging rubber blades, and charging tubes. Known chargers such as non-contact-type roller chargers, and scorotron chargers and corotron chargers that utilize corona discharge are also used.

### Exposing Device

Examples of the exposing device 9 include optical devices that can apply light, such as semiconductor laser light, LED light, or liquid crystal shutter light, into a particular image shape onto the surface of the electrophotographic photoreceptor 7. The wavelength of the light source is to be within the spectral sensitivity range of the electrophotographic photoreceptor. The mainstream wavelength of the semiconductor lasers is near-infrared having an oscillation wavelength at about 780 nm. However, the wavelength is not limited to this, and a laser having an oscillation wavelength on the order of 600 nm or a blue laser having an oscillation wavelength of 400 nm or more and 450 nm or less may also be used. In order to form a color image, a surface-emitting laser light source that can output multi beams is also effective.

### Developing Device

Examples of the developing device 11 include common developing devices that perform development by using a developer in contact or non-contact manner. The developing device 11 is not particularly limited as long as the aforementioned functions are exhibited, and is selected according to the purpose. An example thereof is a known developer that has a function of attaching a one-component developer or a two-component developer to the electrophotographic photoreceptor 7 by using a brush, a roller, or the like. In particular, a development roller that retains the developer on its surface may be used.

The developer used in the developing device 11 may be a one-component developer that contains only a toner or a two-component developer that contains a toner and a carrier. The developer may be magnetic or non-magnetic. Known developers are used as these developer.

### Cleaning Device

A cleaning blade type device equipped with a cleaning blade 131 is used as the cleaning device 13. A fur brush cleaning method or a simultaneous development/cleaning method may be employed instead of the cleaning blade method.

### Transfer Device

Examples of the transfer device 40 include contact-type transfer chargers that use belts, rollers, films, rubber blades, etc., and known transfer chargers such as scorotron transfer chargers and corotron transfer chargers that utilize corona discharge.

### Intermediate Transfer Body

A belt-shaped member (intermediate transfer belt) that contains semi-conducting polyimide, polyamide imide, polycarbonate, polyarylate, a polyester, a rubber, or the like is used as the intermediate transfer body 50. The form of the intermediate transfer body other than the belt may be a drum.

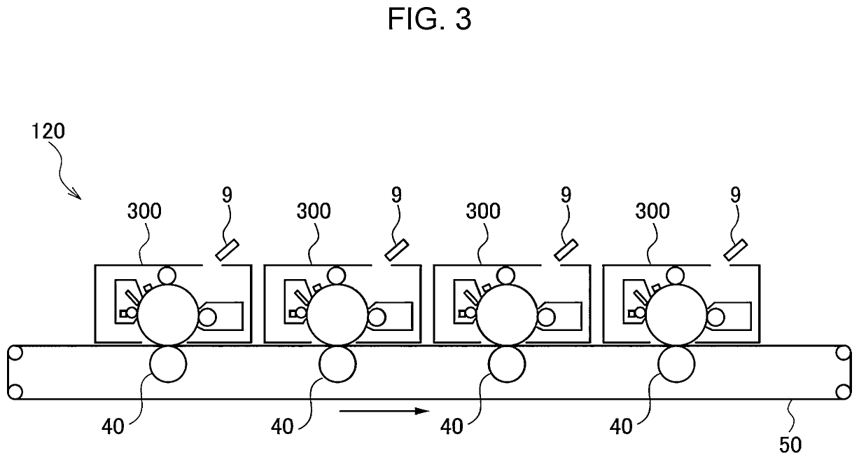

FIG. 3 is a schematic cross-sectional view of one example of an image forming apparatus according to one exemplary embodiment.

An image forming apparatus 120 illustrated in FIG. 3 is a tandem-system multicolor image forming apparatus equipped with four process cartridges 300. In the image forming apparatus 120, four process cartridges 300 are arranged side-by-side on the intermediate transfer body 50, and one electrophotographic photoreceptor is used for one color. The image forming apparatus 120 is identical to the image forming apparatus 100 except for the tandem system.

### EXAMPLES

In the description below, the exemplary embodiments of the present disclosure are described in further detail through examples, and these examples do not limit the exemplary embodiments of the present disclosure in any way.

In the description below, “parts” and “%” are on a mass basis unless otherwise noted.

In the description below, syntheses, processes, production, etc., are carried out at room temperature (25° C.±3° C.) unless otherwise noted.

The elastic deformation rate of a resin is determined by the following method.

The elastic deformation rate of a resin is determined from the equation below.

$$Elastic deformation rate = ( D max - D 1 ) / D max$$

Here, the total deformation amount of a photosensitive layer under load is split into an elastic deformation amount and a plastic deformation amount, and the elastic deformation rate is defined as elastic deformation rate=elastic deformation amount/total deformation amount.

The elastic deformation rate is measured in an environment having a temperature of 24° C. and a humidity of 50% RH by using Nanoindenter SA2 produced by MTS by performing an indentation test of indenting a surface of a photosensitive layer with the resins exposed therein using a diamond Berkovich indenter at an indentation rate of 0.025 μm/s to an indentation depth of 0.5 μm. In this measurement, the strain depth is determined, as the deformation amount not recovered due to the load, by the deformation amount (depth) of the resin at the time the measurement has ended, and the maximum indentation depth is assumed to be 0.5 μm, which is the indentation depth of the diamond Berkovich indenter.

### Preparation of Polyarylate Resin PA1

Into a reactor equipped with a stirrer, 12.7220 g of 2,2′-dimethyl-4,4′-(1,3-dimethylbutylidene)diphenol, 0.1233 g of 4-t-butylphenol, 0.0632 g of hydrosulfite sodium, and 240 mL of water are added and stirred into a suspension. To this suspension, 4.8392 g of sodium hydroxide, 0.1981 g of benzyltributylammonium chloride, and 160 mL of water are added under stirring at a temperature of 20° C., and the resulting mixture is stirred in a nitrogen atmosphere for 30 minutes. To the resulting aqueous solution, 220 mL of o-dichlorobenzene is added, the resulting mixture is stirred in a nitrogen atmosphere for 30 minutes, and then 12.0000 g of a powder of 4,4′-biphenyldicarbonyl chloride is added thereto. After completion of the addition, the reaction is allowed to proceed at a temperature of 20° C. in a nitrogen atmosphere while stirring for 4 hours. The solution after polymerization is diluted with 300 mL of o-dichlorobenzene, and an aqueous layer is removed. The residue is washed with a diluted acetic acid solution and ion exchange water and then injected into methanol to deposit a polymer. The deposited polymer is filtered out and dried at 50° C.

The obtained polymer is subjected to the following post process to obtain a final product.

The polymer is redissolved in 900 mL of tetrahydrofuran, and the resulting solution is injected into methanol to deposit a polymer. The deposited polymer is filtered out, washed with methanol, and dried at 50° C. This operation is performed three times, as a result of which 17.5 g of a polyarylate resin PA1, which is a white polymer, is obtained.

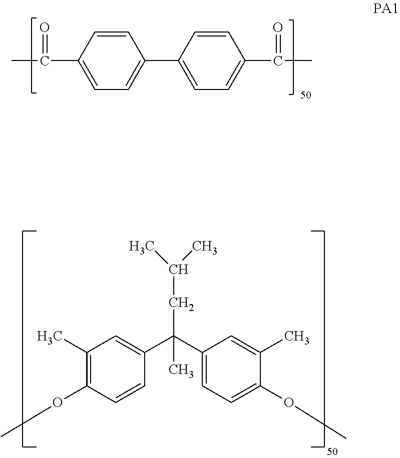

### Polyester Resin PA2

A polyester resin PA2 containing 50 mol % of the dicarboxylic acid unit (A-12) described above and 50 mol % of the diol unit (B-24) described above is prepared.

### Polycarbonate Resins PB1 to PB3

Polycarbonate resins PB1 to PB3 described below are prepared.

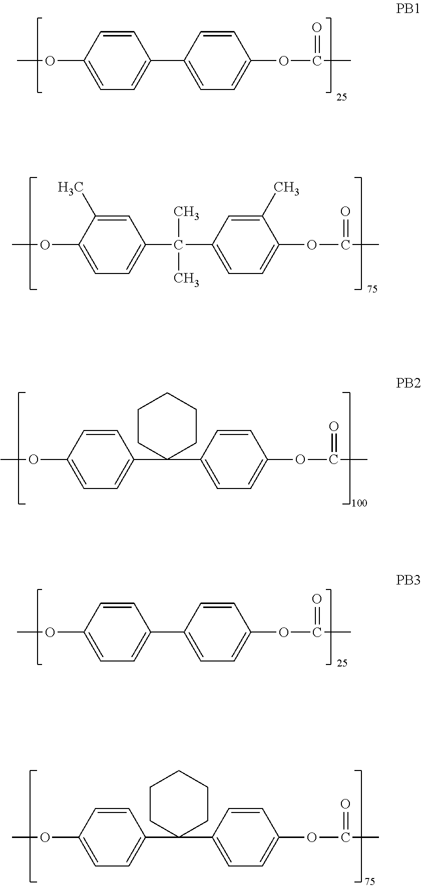

Note that a figure on the lower right of a square bracket in PA1 and PB1 to PB3 indicates a molar ratio.

### Polyester Resin PB4

A polyester resin PB4 containing 50 mol % of the dicarboxylic acid unit (A-12) described above, 37.5 mol % of the diol unit (B-2) described above, and 12.5 mol % of the diol unit (B-4) described above is prepared.

### Examples 1 to 15 and Comparative Examples 1 to 4

A total of 52.75 parts of the resin A and the resin B indicated in Table at a mass ratio indicated in Table, 1.25 parts of a V-type hydroxygallium phthalocyanine (having diffraction peaks at least at Bragg's angles (2θ±0.2°) of 7.3°, 16.0°, 24.9°, and) 28.0° in an X-ray diffraction spectrum taken with a CuKα specific X-ray) serving as a charge generation material, 7.8 parts of example compound 2-2 described above serving as an electron transport material, 38.2 parts of compound CTM-1 below included in formula (G2) serving as a hole transport material (mass ratio of electron transport material (formula 2-2) to a hole transport material CTM-1:17:83), and 175 parts of tetrahydrofuran and 75 parts of toluene serving as solvents are mixed, and the resulting mixture is dispersed in a sand mill with glass beads having a diameter of 1 mm for 4 hours so as to obtain a single layer-type photosensitive layer-forming solution. The photosensitive layer-forming solution is applied to an aluminum substrate having an outer diameter of 30 mm, a length of 244.5 mm, and a thickness of 1 mm by a dip coating method, and is dried and cured at a temperature of 110° C. for 40 minutes to form a single layer-type photosensitive layer having an average thickness of 37 μm and obtain a positively chargeable electrophotographic photoreceptor.

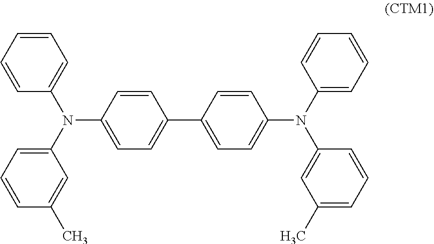 [SMILES: Cc1cccc(N(c2ccccc2)c2ccc(-c3ccc(N(c4ccccc4)c4cccc(C)c4)cc3)cc2)c1]

### Evaluation

### Corrosion-Induced Color Spot Generation Reducing Property

Corrosion-induced color spots are evaluated by using a modified machine of HL5340D produced by Brother Industries, Ltd., equipped with a photoreceptor and by printing-out 2,000 sheets of a 50% halftone image in a high-temperature, high-humidity environment of 28° C. and 85% RH at a charging voltage of +800 V, turning-off the machine overnight, and feeding a blank sheet of paper next morning so that the color spots are evaluated under the following criteria by counting the color spots generated on the blank sheet of paper.
A: No color spots found.
B: One to nine color spots found.
C: Ten or more color spots found.

### Wear Resistance

The wear resistance is evaluated by outputting a halftone image having an image density of 30% on 10,000 sheets of A4 paper by using the same modified machine described above, measuring the thickness of the photoreceptor with an Eddy current-type thickness meter (produced by FISCHER INSTRUMENTS K. K.) before and after this outputting, and dividing the amount in which the thickness has decreased by the number of test cycles to determine the decrease in film thickness.

The evaluation standard is as follows.
A: 5 nm/kcy or less.
B: More than 5 nm/kcy but not more than 10 nm/kcy.
C: More than 10 nm/kcy but not more than 20 nm/kcy.
D: More than 20 nm/kcy.

TABLE

| | Resin A | | Resin B | | Physical properties | | Evaluation | |
|---|---|---|---|---|---|---|---|---|
| | | Elastic | | Elastic | Elastic | Resin | Color spot | |
| | | deformation | | deformation | deformation | ratio | generation | Wear |
| | Type | rate (%) | Type | rate (%) | rate (%) | MA/MB | reduction | resistance |
| Example 1 | PA1 | 58.0 | PB1 | 45.2 | 12.8 | 9.00 | B | A |
| Example 2 | PA1 | 58.0 | PB1 | 45.2 | 12.8 | 2.33 | B | A |
| Example 3 | PA1 | 58.0 | PB1 | 45.2 | 12.8 | 1.00 | A | A |
| Example 4 | PA1 | 58.0 | PB1 | 45.2 | 12.8 | 0.43 | B | A |
| Example 5 | PA1 | 58.0 | PB1 | 45.2 | 12.8 | 0.11 | B | A |
| Example 6 | PA1 | 58.0 | PB2 | 44.0 | 14.0 | 9.00 | B | A |
| Example 7 | PA1 | 58.0 | PB2 | 44.0 | 14.0 | 2.33 | B | A |
| Example 8 | PA1 | 58.0 | PB2 | 44.0 | 14.0 | 1.00 | A | A |
| Example 9 | PA1 | 58.0 | PB2 | 44.0 | 14.0 | 0.43 | B | B |
| Example 10 | PA1 | 58.0 | PB2 | 44.0 | 14.0 | 0.11 | B | B |
| Example 11 | PA2 | 53.8 | PB4 | 40.1 | 13.7 | 9.00 | B | A |
| Example 12 | PA2 | 53.8 | PB4 | 40.1 | 13.7 | 2.33 | B | A |
| Example 13 | PA2 | 53.8 | PB4 | 40.1 | 13.7 | 1.00 | A | A |
| Example 14 | PA2 | 53.8 | PB4 | 40.1 | 13.7 | 0.43 | B | B |
| Example 15 | PA2 | 53.8 | PB4 | 40.1 | 13.7 | 0.11 | B | B |
| Comparative | PA1 | 58.0 | — | — | — | — | C | A |
| Example 1 | | | | | | | | |
| Comparative | — | — | PB1 | 45.2 | — | — | C | C |
| Example 2 | | | | | | | | |
| Comparative | PA1 | 58.0 | PB3 | 48.0 | 10.0 | 1.00 | C | A |
| Example 3 | | | | | | | | |
| Comparative | PA1 | 58.0 | PB4 | 40.1 | 17.9 | 1.00 | A | C |
| Example 4 | | | | | | | | |

As indicated in Table, the positively chargeable electrophotographic photoreceptors of Examples 1 to 15 exhibit excellent corrosion-induced color spot generation reducing properties and wear resistance compared to the positively chargeable electrophotographic photoreceptors of Comparative Examples 1 to 4.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) A positively chargeable electrophotographic photoreceptor comprising: a single layer-type photosensitive layer that contains a hole transport material, an electron transport material, a charge generation material, and a binder resin, wherein the binder resin contains a resin A having an elastic deformation rate of 53.0% or more and a resin B having an elastic deformation rate difference of 12% or more and 17% or less with respect to the resin A.
(((2))) The positively chargeable electrophotographic photoreceptor described in (((1))), wherein a mass ratio MA/MB of a content MA of the resin A to a content MB of the resin B is 0.25 or more and 4 or less.
(((3))) The positively chargeable electrophotographic photoreceptor described in (((2))), wherein the mass ratio MA/MB of the content MA of the resin A to the content MB of the resin B is 0.4 or more and 2.5 or less.
(((4))) The positively chargeable electrophotographic photoreceptor described in any one of (((1))) to (((3))), wherein the resin B has an elastic deformation rate difference of 13% or more and 16% or less with respect to the resin A.
(((5))) The positively chargeable electrophotographic photoreceptor described in any one of (((1))) to (((4))), wherein an elastic deformation rate of the resin B is 12% or more and 17% or less smaller than the elastic deformation rate of the resin A.
(((6))) The positively chargeable electrophotographic photoreceptor described in any one of (((1))) to (((5))), wherein the resin A is a polyarylate resin.
(((7))) The positively chargeable electrophotographic photoreceptor described in any one of (((1))) to (((6))), wherein the resin B is a polycarbonate resin.
(((8))) The positively chargeable electrophotographic photoreceptor described in any one of (((1))) to (((7))), wherein the resin A has a biphenyl structure.
(((9))) The positively chargeable electrophotographic photoreceptor described in any one of (((1))) to (((8))), wherein the resin B has a biphenyl structure.
(((10))) A process cartridge detachably attachable to an image forming apparatus, the process cartridge comprising the positively chargeable electrophotographic photoreceptor described in any one of (((1))) to (((9))).
(((11))) An image forming apparatus comprising: the positively chargeable electrophotographic photoreceptor described in any one of (((1))) to (((9))); a charging device that charges a surface of the electrophotographic photoreceptor; an electrostatic latent image forming device that forms an electrostatic latent image on the charged surface of the electrophotographic photoreceptor; a developing device that develops the electrostatic latent image on the surface of the electrophotographic photoreceptor by using a developer containing a toner so as to form a toner image; and a transfer device that transfers the toner image onto a surface of a recording medium, wherein the charging device has a positive charging system.

What is claimed is:

1. A positively chargeable electrophotographic photoreceptor comprising:
a single layer-type photosensitive layer that contains a hole transport material, an electron transport material, a charge generation material, and a binder resin,
wherein the binder resin contains a resin A having an elastic deformation rate of 53.0% or more and a resin B having an elastic deformation rate difference of 12% or more and 17% or less with respect to the resin A.

2. The positively chargeable electrophotographic photoreceptor according to claim 1, wherein a mass ratio MA/MB of a content MA of the resin A to a content MB of the resin B is 0.25 or more and 4 or less.

3. The positively chargeable electrophotographic photoreceptor according to claim 2, wherein the mass ratio MA/MB of the content MA of the resin A to the content MB of the resin B is 0.4 or more and 2.5 or less.

4. The positively chargeable electrophotographic photoreceptor according to claim 1, wherein the resin B has an elastic deformation rate difference of 13% or more and 16% or less with respect to the resin A.

5. The positively chargeable electrophotographic photoreceptor according to claim 1, wherein an elastic deformation rate of the resin B is 12% or more and 17% or less smaller than the elastic deformation rate of the resin A.

6. The positively chargeable electrophotographic photoreceptor according to claim 1, wherein the resin A is a polyarylate resin.

7. The positively chargeable electrophotographic photoreceptor according to claim 1, wherein the resin B is a polycarbonate resin.

8. The positively chargeable electrophotographic photoreceptor according to claim 1, wherein the resin A has a biphenyl structure.

9. The positively chargeable electrophotographic photoreceptor according to claim 1, wherein the resin B has a biphenyl structure.

10. A process cartridge detachably attachable to an image forming apparatus, the process cartridge comprising the positively chargeable electrophotographic photoreceptor according to claim 1.

11. A process cartridge detachably attachable to an image forming apparatus, the process cartridge comprising the positively chargeable electrophotographic photoreceptor according to claim 2.

12. A process cartridge detachably attachable to an image forming apparatus, the process cartridge comprising the positively chargeable electrophotographic photoreceptor according to claim 3.

13. A process cartridge detachably attachable to an image forming apparatus, the process cartridge comprising the positively chargeable electrophotographic photoreceptor according to claim 4.

14. A process cartridge detachably attachable to an image forming apparatus, the process cartridge comprising the positively chargeable electrophotographic photoreceptor according to claim 5.

15. A process cartridge detachably attachable to an image forming apparatus, the process cartridge comprising the positively chargeable electrophotographic photoreceptor according to claim 6.

16. A process cartridge detachably attachable to an image forming apparatus, the process cartridge comprising the positively chargeable electrophotographic photoreceptor according to claim 7.

17. A process cartridge detachably attachable to an image forming apparatus, the process cartridge comprising the positively chargeable electrophotographic photoreceptor according to claim 8.

18. A process cartridge detachably attachable to an image forming apparatus, the process cartridge comprising the positively chargeable electrophotographic photoreceptor according to claim 9.

19. An image forming apparatus comprising:
the positively chargeable electrophotographic photoreceptor according to claim 1;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image on the surface of the electrophotographic photoreceptor by using a developer containing a toner so as to form a toner image; and
a transfer device that transfers the toner image onto a surface of a recording medium,
wherein the charging device has a positive charging system.

20. An image forming apparatus comprising:
the positively chargeable electrophotographic photoreceptor according to claim 2;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image on the surface of the electrophotographic photoreceptor by using a developer containing a toner so as to form a toner image; and
a transfer device that transfers the toner image onto a surface of a recording medium,
wherein the charging device has a positive charging system.
